(19) United States
(12) Patent Application Publication
(10) Pub. No.: US 2025/0375955 A1
(43) Pub. Date: Dec. 11, 2025

(54) INTEGRATED ARTICLE OF METAL ALLOY MATERIAL FOR STRUCTURE WITH CFRP MATERIAL BY ADHESION AND METHOD FOR ASSEMBLING THE SAME

(71) Applicant: ANDOH-Corporation limited partnership company, Kanagawa (JP)

(72) Inventor: Naoki ANDOH, Kanagawa (JP)

(73) Assignee: ANDOH-Corporation limited partnership company, Kanagawa (JP)

(21) Appl. No.: 19/228,797

(22) Filed: Jun. 5, 2025

(30) Foreign Application Priority Data
Jun. 5, 2024 (JP) 2024- 91702

(51) Int. Cl. B32B 15/08; B32B 7/12; B32B 15/20; B32B 37/12

(52) U.S. Cl. CPC B32B 15/08; B32B 7/12; B32B 15/20; B32B 37/12; B32B 2037/1253; B32B 2262/106; B32B 2311/18; B32B 2311/24

(57) ABSTRACT

The present disclosure is used for a mechanical structure such as a joined structure of a main wing portion with body portion of an airplane. A CFRP material and Al alloy A6061 material are joined by adhesion preliminarily. An Al alloy A6061 sheet has high expandability and thermal conductivity along with high followability to thermal shrinkage or elastic deformation due to mechanical load of the CFRP plate material. Faces with fine irregularities are formed on front and backside faces of a hardened adhesive having been prepared separately by mechanical working means. The Al alloy A6061 material and 64Ti alloy material are joined by adhesion onto respective faces with fine irregularities of the hardened adhesive. In this adhesion, complete adhesion is conducted by extracting air in an autoclave, placing the article under a high temperature and leaving cooled.

### CROSS-REFERENCE TO RELATED APPLICATION

This application claims the priority benefit of Japan application serial No. 2024-091702, filed on Jun. 5, 2024. The entirety of the above-mentioned patent application is hereby incorporated by reference herein and made a part of this application.

### FIELD OF THE INVENTION

The present invention relates to an integrated article of a metal alloy material for structure with a CFRP (Carbon Fiber Reinforced Plastics) material by adhesion and a method for assembling the same. More specifically, the present invention relates to an integrated article of a metal material for structure having a high strength and a CFRP material as different kinds of materials joined each other by adhesive, in a structural body such as an airplane or drone, and a method for assembling the same.

### BACKGROUND OF THE INVENTION

At least 15 years have already passed since CFRP material has come to be used as an ultralight material with high strength for a main structural material for a main wing, etc., of a largescale passenger airplane. In such body structure, a CFRP member as a main wing is joined to be fixed with a central member of the body made of ultra-super duralumin (an alloy of a type Al—Zn—Mg—Cu (Al alloy “A7075” in JIS). In general, as a method for fixing securely two kinds of large-scale materials having high strength each other, there are such a method as by welding or a method with a bolt-nut, while a method by rivet was also used previously. In this, the method by welding cannot be employed for a case other than of joining metal materials each other, and the method with a bolt-nut cannot avoid much bother in a case where objects to be fixed are of plate material of CFRP, etc. This is because it should be considered that, while CFRP itself is a material with high strength that can be substituted for a metal material and with sufficiently high hardness, it is essentially fiber reinforced material and has large hazardousness for applying a method with a bolt-nut for assembling main members of an airplane. That is, when holes are formed on both of a plate material of CFRP and a plate material of Al alloy, a bolt is caused to pass through the holes and both materials are fastened by a nut with a washer added, for example, cracks are created necessarily in a peripheral portion of the plate material of CFRP where holes are formed. Common methods for coping with such cases are to select suitable material of the washer and suitable diameter and thickness thereof and to adjust fastened state by the nut in suitable management and checking of fastening pressure of the washer after assembled. However, this is a quite difficult matter in practice. Because an airplane is subjected to a violent change of temperature such as a low temperature of −60° C. in high altitude flying, a high temperature of +50° C. in outside storing after having landed onto an airport in tropical area.

In such a case, while the material used for a central member of the body is Al alloy A7075 as explained above, a material to be joined with a CFRP plate material is supposed to be 64Ti alloy (JIS) for understandability. In such a case, coefficient linear expansions of a CFRP plate material and a 64Ti alloy plate material are (5˜7)×10⁻⁵K⁻¹ for CFRP material and 0.8×10⁻⁵K⁻¹ for Ti alloy material respectively in the thick portion thereof, and linear expansion coefficient of a usually used specific steel material for a bolt is known as to be about 1.5×10⁻⁵K⁻¹. As a result, although fastening with a nut seems to have been done to a suitable value (torque) in a time of an ordinary temperature, value of thickness of plate materials is necessarily reduced at a temperature of −50° C. in high-altitude flying, which creates loosening of the nut. Adversely, if temperature becomes high of +50° C. or more, value of thickness of plate materials increases, and as a result, the nut becomes fastened state without fastening operation. In short, adjustment of torque for fastening nuts is such a troublesome matter, so to say, as requiring to automate the fastening system itself. Of course, the simplest solving method is to adjust temperature of the portion around the central portion of the body itself, where such members including the base of the main wing are gathered, to be near to an ordinary temperature.

This temperature adjusting scheme is surely a good idea because big change in external temperature can be restrained. However, in a case that after one of large-scale airplanes that fly usually around the world is parked at Alaska or Siberia in winter and an accident in fuel supply or breaking of power supply line occurs, such a situation that temperature adjusting device ceases can be brought about. It was considered to be impossible for the Boeing Company as the largest company producing airplanes to employ a bolt-nut joining method for this most important assembled portion. Therefore, the Boeing Company seems to have come to employ a rivet joining method that has been accumulated basically in the airplane industry as a proper procedure heretofore. In this, the rivets that the Boeing Company used for the B787, etc., as an airplane with CFRP material used are rivets of a very large type, somewhat heavy ones made of Ti alloy, quite different from those made of Al alloy used before.

### (Inventions Precedent to the Present Invention)

The present inventor presented an insert molding method (joining by injection molding) that comprises applying specific chemical surface treatment to a metal material including a metal and a metal alloy, then inserting the metal piece into a metallic mold of an injection molding machine and injecting crystalline thermoplastic resin therein to integrating a metal material with a resin material. In this, it was found that a composite in which the metal material completely integrated with molded resin portion by injection is obtained and joining strength between the metal material and the molded article of resin, that is, both of shear joining strength and tensile joining strength become about 40 MPa. The method for measuring strength and the test piece used at this time is as shown FIGS. 1 to 3. As shown in FIG. 1, the underside plate material of the test piece is a metal piece and the upper side plate of the test piece is a resin piece that has been injected and solidified. Area for adhesion (fixation) of both plates are 0.5 cm² (10 mm×5 mm). FIG. 2 shows a jig for attaching a test piece to a shear tensile test machine. FIG. 3 shows a shape of another joined article by injection molding formed by using another metallic mold for injection molding, the joined article being a test piece for measuring tensile strength of an article of a metal piece and a resin piece joined to confront each other. These are known to Japanese chemical engineers (persons occupied in techniques) as “technique of joining by injection molding” or as “NMT (Nano Molding Technology)” named by the present inventor. This measuring method is of known techniques and standardized as “International Standard of Plastics-Evaluation of the adhesion interface performance in plastic metal assemblies (ISO19095)” (disclosed in Patent Document 1).

At this time, the present inventor Naoki Andoh thought that NMT as this “joining techniques by injection molding” can be applied to joining techniques by adhesive as it is, and then, specifically took notice of joining techniques by adhesive using one part epoxy resin adhesive regarding adhesion of metal materials including metal alloys each other, thus attained success for preparing a joined article by adhesion having high strength. Shear joining strength and tensile joining strength of joined pairs obtained by adhesion was about 60 MPa and even strength of 90 MPa was attained for tensile strength by joining alone. Patent Documents 1 to 7 as below discloses content of such inventions. The inventor remarked that these inventions can be used not only for joining techniques by adhesion of metal pieces each other but also for joining techniques of a metal material piece with a CFRP material piece and supposed shear joining strength of the latter as of about 40 MPa can be attained by experiment. These came to be known as “New techniques of joining by adhesion” or “NAT (Nano Adhesion Technology)”. In this, test pieces for NAT as shown FIGS. 4A, 4B and 5, substantially similar as those for NMT shown in FIGS. 1 and 3, were used for measuring shear joining strength by adhesion and tensile joining strength by adhesion. Chemical treatment of metal surface by NAT will be called as NAT treatment and joined articles based on the same will be called as joined articles of NAT type, etc., bellow.

Further, the present inventor found that, although joining strength of NAT type pair joined by adhesion of metal alloy pieces having near values of linear expansion coefficient each other is 60 MPa, joining strength of NAT type pair joined by adhesion of metal pieces or metal alloy pieces having values of linear expansion coefficient with large difference is observed not to reach 60 MPa at all but to decrease sometimes 0 to several MPa. Further, it was found that shear joining strength of a pair joined by adhesion of quite similar CFRP pieces each other is divided into two levels of about 40 MPa and 50 to 60 MPa. Here, also it was found that this was caused by difference of methods for producing CF (Carbon fiber) itself and, with CFRP material using CF produced for use in an airplane and having a highest tensile strength up to about 6 GPa, shear joining strength of a pair of the CFRP materials each other is about 40 MPa. Furthermore, when a CFRP piece having exhibited 40 MPa in the joining of the CFRP pieces by adhesion each other is joined with an Al alloy piece having been subjected to NAT treatment joined by adhesion each other and having exhibited 60 MPa in the joining of the metal alloy materials, shear joining strength by adhesion of the joined article is measured, it resulting in about 40 MPa.

These experimental results show that a joined article of a same kind of materials exhibits high joining strength and a joined article of different kinds of materials exhibits low joining strength. Understanding matters of linear expansion coefficient, directionality thereof, etc., of CFRP plate pieces not so well at that time, the present inventor recognized at least that the linear expansion coefficient is near to zero at least for the plate face side (front or back side) of the CFRP material. Shear joining strength by adhesion of a joined article of metal pieces having been subjected to NAT treatment and having substantially same linear expansion coefficients each other is about 60 MPa. Though shear joining strength by adhesion of a joined article of metal pieces having been subjected to NAT treatment and having linear expansion coefficients much different from each other is extensively low, shear joining strength by adhesion of a joined article of CFRP plate pieces having been subjected to NAT type surface treatment (not by chemical treatment but by treatment of forming surface with fine irregularities by mechanical working such as with sandpaper, etc.) is about 40 MPa. It was quite mysterious and difficult for understanding that shear joining strength of the joined pair of the CFRP plate piece with the plate piece of Al alloy A7075 is substantially same as of 40 MPa. Then, basic data will be explained for techniques of joining by adhesive at first, below.

For a pair joined by adhesion, at first, there is a case that linear expansion coefficient of a plate piece quite disregards linear expansion coefficient of a sheet piece, even difference between them is large. The present inventor had understood that it is necessary above all to raise heat resistance of one part epoxy resin adhesive in promoting study and development regarding NAT. This is because, though shear joining strength of a pair joined by adhesion obtained at this time by use of commercially available one part epoxy resin adhesive was so high of about 60 MPa at an ordinary temperature as to be surprised at, it was so low of 5˜7 MPa under a high temperature of 150° C. also as to be surprised at. This fact led to an invention disclosed in Patent Document 8 regarding development of one part epoxy resin adhesive having heat resistance by the present inventor, whose proper technical field is high molecular chemistry. Then, for NAT type adhesion of metal pieces having substantially same linear expansion coefficient, such an adhesive composition (a composition disclosed in Patent Document 8) came to be obtained that exhibits a high shear joining strength by adhesion of about 45 MPa at a high temperature of 150° C. or even over 60 to 70 MPa at an ordinary temperature of 25° C.

Further, along with promoting such study for developing heat resistant adhesive, the present inventor acquired commercially available one part epoxy resin adhesives including domestic one or from foreign countries and, overlaying the acquired adhesives on Al alloy A 7075 pieces having been subjected to NAT treatment, measured shear joining strength of joined pairs of the Al alloy pieces each other. One part adhesive most excellent in this field of adhesive in the world can be found with this experimental study, and it seemed at this time that no one other than the present inventor having established NAT can utilize this measure and also that the present inventor himself must do. At this time, “EW2040” (sold by Three M Japan Co. Ltd., main company in Tokyo, Japan) was found searching in the market of adhesives. In short, adhesives taken as excellent ones to be employed were of two kinds, that is, an adhesive the present inventor invented (a kind of adhesive named as No. 4 disclosed in Patent Document 8) and another adhesive as mentioned above sold in Japan afterwards. As the latter “EW2040” is a mass-produced adhesive with quality control by a large firm in USA and seemed to have reliability, the present inventor used the latter more than the former, in the study of NAT after it.

Here, though adhesives are improved to exhibit high heat resistance, for a pair of different kinds of metal alloy pieces having distinctly different linear expansion coefficient respectively, each being of a plate with thickness of 3 to 6 mm, joined by adhesion each other, for example, in a case where a plate piece of Al alloy A7075 having a linear expansion coefficient of 2.3×10⁻⁵K⁻¹ and a plate piece of stainless steel SUS304 having a linear expansion coefficient of 1.5×10⁻⁵K⁻¹ or a plate piece of stainless steel SUS304 having a linear expansion coefficient of 1.5×10⁻⁵K⁻¹ and a plate piece of 64 Ti alloy 0.8×10⁻⁵K⁻¹ having a linear expansion coefficient of 0.8×10⁻⁵K⁻¹, in which difference between the two linear expansion coefficients is large as (0.8˜0.7)×10⁻⁵K⁻¹, shear joining strength of a pair of pieces, having been subjected to NAT treatment and joined with each other for which shear joining strength with an area of adhesion in a scale of about 0.5 cm² as shown in FIGS. 4A and 4B was measured, became decreased by a large extent to 10˜15 MPa. While this is a natural matter, when a pair of metal pieces having been subjected to NAT treatment are joined with each other using a heat resistant one part epoxy resin adhesive, which is taken as completely hardened by heating in 20 minutes at 150° C., these metal pieces has come to be integrated completely at a temperature of 150° C. When temperature is lowered to an ordinary with the integrated article left alone, both metal pieces are cooled down by 125° C. and each piece comes to be shortened to different length according to its own linear expansion coefficient. In a case where both are metal plates having high tensile strength and are cooled down with high speed, there may be a case that they rebound with sound and even may be torn off. When they are cooled down slowly, they are peeled off from a peripheral joined portion by adhesion and, with central portion joined by adhesion remaining in a circular shape, are broken off in the tensile test.

As compared with this, in a case where pieces of the joined pair of different kinds of metal materials have different thickness and difference between linear expansion coefficient thereof is large, as a case that one piece is a plate piece with a thickness of 3˜6 mm and the other is a sheet piece of about 0.5 mm, for example, in a case of Al ally A 6061 (JIS) with a thickness of 0.5 mm (with a linear expansion coefficient of 2.3×10⁻⁵K⁻¹) and SUS304 (JIS) with a thickness of 3 mm (with a linear expansion coefficient of 1.5×10⁻⁵K⁻¹), shear joining strength by adhesion of the joined pair having been subjected to NAT treatment and joined by adhesion is 57 to 58 MPa near to 60 MPa, with linear expansion coefficient of the thin piece of Al alloy A6061 being lowered by the piece of SUS304. Both of the sheet piece and the plate piece have been integrated with a strong adhesion force under a temperature of 150° C. as solidification point of the adhesive, and the sheet piece remains to be attached to the plate piece after temperature has been lowered to ordinary one. In short, even if sheet piece of metal alloy has high tensile strength and its own linear expansion coefficient for itself originally, these are disregarded when joining strength by adhesion is high and the sheet piece follows the plate piece side with elongation-contraction within allowable elastic deformation. Of course, practitioners without acquiring NAT treatment techniques providing high adhesion strength cannot find and recognize this phenomenon, as pieces are peeled before this phenomenon.

In this, it is not possible to prepare the above-mentioned pair of an Al alloy A 6061 piece with a thickness of 0.5 mm (with a linear expansion coefficient of 2.3×10⁻⁵K⁻¹) and a SUS304 (JIS) piece with a thickness of 3 mm (with a linear expansion coefficient of 1.5×10⁻⁵K⁻¹) joined by adhesion as shown in FIG. 4A and to measure shear joining strength by adhesion as it is. This is because when the Al alloy A6061 piece, being a sheet material, is pulled for breaking, it begins to be bent as its underside portion (side of adhesion) is elongated more than its upper side thus creating moment breaking with a bending moment before shear breaking occurs as it is. That is, as moment breaking occurs before shear breaking, shear joining strength cannot be measured. Then, when a pair of pieces of a plate piece with a thickness of 3˜6 mm and a sheet piece with a thickness of 0.1 to 0.5 mm joined each other by adhesion with a joining area of about 0.5 cm² in a shape shown in FIGS. 4A and 4B is prepared and tensile breaking is tried as it is, the test pair is broken without creating shear breaking. Due to this, another plate piece with a thickness of about 3 mm and a same shape as the sheet piece is formed and also caused to be subjected to NAT treatment. After this, one face of this plate piece and also one face of the sheet piece of the pair having been joined by adhesion are overlayed with commercially available two-part adhesive hardened at an ordinary temperature, then the plate piece is laid on the sheet side of the pair having been joined to be joined by adhesion for the whole surface joining with several click stops added. Leaving this at 50° C. for 48 hours if possible or within a room for a month or so, certain strength by adhesion is attained. It is suitable to measure shear joining strength by adhesion in this situation. The two-part adhesive is used for adding a plate piece in order to prevent moment breaking from being created.

### (Lenear Expansion Coefficient of CFRP Plate Piece Changes so Much According to how to Laminate Prepregs)

A CFRP material is a plate shaped article of an elongated form obtained by laminating CFRP prepregs (a wide film shaped article obtained by impregnating CF cloth or bundles CF aligned to be in unidirectional with one part epoxy resin adhesive) by several to several decade sheets or more than a hundred sheets and causing adhesive constituent in the prepreg to be solidified by heating, or an article obtained by cutting off therefrom. As such, a CFRP material is surely also an article of hardened adhesive as a plastic product, which is not such a thermoplastic resin product used in techniques of joining by injection molding as explained first above but a thermosetting resin product. Thermosetting resin product has thermal physicality much different from thermoplastic resin and, being a plastic, has further high tensile strength than thermoplastic resin. If a pair of CFRP material pieces joined each other by adhesion is prepared in a best level with a determined adhesive, shear joining strength measured for a shaped article (test piece) as shown in FIGS. 4A and 4B is about 40 MPa. In the next, how about preparing a pair of Al alloy A7075 pieces having been subjected to NAT treatment joined each other by adhesion and measuring its shear joining strength? Even if measurement of its shear joining strength is conducted for a shaped article in the form shown in FIGS. 4A and 4B, mistake may occur without arranging elementary techniques.

As for details of CFRP materials, these are divided into several kinds, which corelate much with values of linear expansion coefficient, and there are also hybrids of CFRP and GFRP, thus it is necessary to understand these. To say of manner of alignment of prepregs of CFRP, GFRP, etc., for example, for a plate formed by laminating many layers of unidirectional CFRP prepregs to be aligned in the lengthwise direction thereof and then by heating it to be hardened, linear expansion coefficient of the plate in its lengthwise direction becomes 0.1×10⁻⁵K⁻¹. Further, linear expansion coefficient in its crosswise direction becomes very high as of (5˜7)×10⁻⁵K⁻¹, equivalent to that of plastics. On the other hand, in a case where many layers of unidirectional CFRP prepregs are laminated so as to rotate direction of the layers by 90 degrees one another and then heat the laminated to be hardened, linear expansion coefficient of the prepared plate on its surface is guessed to be of 0.1×10⁻⁵K⁻¹ in every direction thereof. There is also one in which many CFRP prepregs of cloth type are laminated and then hardened by heating, providing also linear expansion coefficient of 0.1×10⁻⁵K⁻¹ in every direction on the plate surface. On the other hand, it should be not difficult for technicians in the industry to mass-produce unidirectional GFRP. Placing a layer of unidirectional CFRP prepreg in one direction as lengthwise direction thereof, in the next laminating a layer of GFRP prepreg in a direction rotated by 90 degrees from the first direction, in the next laminating a layer of CFRP prepreg, and so on. By laminating CFRP prepreg layers and GFRP prepreg layers alternately up to several decade layers, a plate shaped article having elongated form with CFRP as main, that is, a special FRP material is prepared. Linear expansion coefficient in this case is 0.1×10⁻⁵K⁻¹ in lengthwise direction and 08×10⁻⁵K⁻¹ in crosswise direction.

While, in a tensile breaking test of a pair of a CFRP piece with an Al alloy A7075 piece joined by adhesion using adhesive “EW2040” in a form shown in FIGS. 4A and 4B, shear joining strength of about 40 MPa was provided in the previous experiment regarding NAT treatment by the present inventor, this will be considered again. This is because explanation of having provided about 40 MPa was quite irrational. The CFRP piece at this time was a plate shaped article formed by laminating CFRP prepreg layers rotating each layer by 90 degrees having linear expansion coefficient of 0.1×10⁻⁵K⁻¹ in both of lengthwise direction and crossing direction. On the other hand, linear expansion coefficient of Al alloy A7075 is 2.3×10⁻⁵K⁻¹, it is considered that abnormality in direction of peeling should be created in all face of adhesion of the pair of 15 mm×6 mm other than the central portion thereof by letting cool after a step of joining and hardening for 20 minutes at 150° C. As four corners of the face of adhesion is apart from the center thereof by 8.087 mm (diagonal of the face of adhesion/2), shift by 0.024 mm is considered to occur by calculation of linear expansion coefficient. If the pair joined by adhesion is of one formed by joining high strength metal alloy plates by adhesion each other in a form as shown in FIGS. 4A and 4B, shear joining strength will decrease to a half without such calculation. However, a pair of a CFRP plate piece and an Al alloy piece joined by adhesion was so strong as to exhibit shear joining strength of 40 MPa in breaking test.

Therefore, the CFRP plate piece is an article formed by laminating unidirectional CFRP prepreg layers rotating each layer by 90 degrees alternately and linear expansion coefficient of the plate piece is 0.1×10⁻⁵K⁻¹ in both of lengthwise direction and crossing direction. As linear expansion coefficient of Al alloy A 7075 as the other part is 2.3×10⁻⁵K⁻¹, portion of the face of adhesion of 15 mm×6 mm of other than the center portion is exposed to letting cool after step of solidification by heating of adhesive at 150° C. for 20 minutes (temperature and time in hardening by heating). It can be understood that thermal shrinkage in lengthwise and widthwise directions and some abnormality in positional relation in each other should occur due to this. Such shift due to thermal shrinkage, though small, is surely created at all sites other than the central point of the face of adhesion. However, such variation cannot be recognized as seen and is in a level that it can be barely observed with a magnifying glass as an observation tool. Further, its shear joining strength of adhesion was measured to be about 40 MPa so that strength was lowered by a very small extent. While this is a very strange matter itself, reason of the fact should be considered.

As the reason or cause for this, primary factor consists in both of thickness of a layer of hardened adhesive (maybe about 0.1 mm in averaged value) and thickness of a surface layer of CFRP material (portion of 0.2 to 0.3 mm). That is, it consists in thickness of a layer of solidified thermosetting resin of 0.3 to 0.4 mm and also in that soft portion of a thick portion of hardened adhesive is transformed under force surrounding area. With the calculation mentioned above, while distance from four corners of an adhesion face portion of about 15 mm×4 mm=0.6 cm² of the adhesion face as shown in FIGS. 4A and 4B to the central point thereof was 7.75 mm, the hardened adhesive on the metal side shrank more than CFRP side by 0.021 mm. This layer of hardened adhesive having a thickness of 0.3 to 0.4 mm was transformed into a trapezoidal form by shrinkage. Here, adhesion force between the two materials is strong so that tiny transformation didn't have influence on adhesion force. On the other hand, it can be understood that the above-mentioned trapezoidal lump (layer of hardened adhesive) as a hardened substance of one part epoxy resin adhesive of (0.3 to 0.4 mm)×(area of adhesion face of about 0.6 cm²) was transformed by a tiny amount under adhesion force from both of upper side and lower side through elastic transformation by its own softness (without any breaking).

In short, a necessary matter as a condition for a joined article by adhesion to be kept eternally as a whole integrated article under a circumstance, for example, one in which an airplane is used (−50˜+150° C.) was to use a high strength CFRP plate material or a special FRP plate material as a high strength material on one hand, and to use 64Ti alloy having low linear expansion coefficient and also to use an adhesive of “EW2040” as explained above or a kind of most excellent one disclosed in “Patent Document 8” on the other hand. Therefore, as most necessary matter, it was recognized to be important to utilize techniques of joining a CFRP plate material with an Al alloy A6061 with adhesive as described in [0012], [0013] and along with this to acquire techniques of increasing thickness of hardened adhesive, as used in joining metal materials having been subjected to NAT treatment each other with adhesive, in such a manner that, when adhesion area is wide as 200 mm×200 mm or so, thickness of the adhesive layer is increased to a level of 3 mm or further to several mm.

### PRIOR ART DOCUMENTS

### Patent Documents

[Patent Document 1] WO2008/114669
[Patent Document 2] WO2008/133096
[Patent Document 3] WO2008/126812
[Patent Document 4] WO2008/133030
[Patent Document 5] WO2008/133275
[Patent Document 6] WO2008/146833
[Patent Document 7] JP, Published Patent Application No. 2010-064397
[Patent Document 8] JP, Published Patent Application No. 2011-006544
[Patent Document 9] JP, Published Patent Application No. 2011-026457
[Patent Document 10] JP, Published Patent Application No. 2011-116950
[Patent Document 11] JP, Published Patent Application No. 2011-148937
[Patent Document 12] JP, Published Patent Application No. 2011-140091

### Non-Patent Documents

Non-Patent Document 1
“International Standardization of Evaluation Method for Joint Performance of Metal-Plastic Assembly ISO19095 Series is published” (Sansouken: National Institute of Advanced Industrial Science and Technology (aist.go.jp))

### SUMMARY OF THE INVENTION

### Problems to be Solved by the Invention

One of the problems concerns a method of joining an Al alloy A7075 member called as an ultra-super duralumin placed in a central portion of a body as explained for an airplane with a CFRP plate as a base member of a main wing. When joining method by adhesion disclosed in Patent Document 12 of invention by the present inventor is employed for the joining here, material of the structural members disposed in the central portion of the airplane may be Al alloy A7075 or 64Ti alloy, and material of the base member of main wing may be a CFRP plate or a specific type of FRP plate in which CFRP and GFRP are laminated alternately. However, experiment using these specific FRP plates and joining by direct adhesion a CFRP plate with an Al alloy A7075 were excluded from problems to be studied as it is considered to depart from the gist of the present invention. That is, it is simpler essentially to employ assembly structure by joining a CFRP material with an Al alloy A7075 plate by adhesion. In the Embodiments of the present invention described later, 64Ti alloy plate is employed as a kind of intermediated material as a matched material to be joined with CFRP plate by adhesion. It was considered to be practically good to join the 64Ti alloy plate with the Al alloy A7075 plate using bolt-nut, etc., as a mechanical joining means. In short, this is based on such a situation that, when circumferential temperature changed from −50° C. to +150° C., difference of elongation between joined materials each other by adhesion is too large for a CFRP material (linear expansion coefficient of 0.1×10⁻⁵K⁻¹) and an Al alloy A7075 (linear expansion coefficient of 2.3×10⁻⁵K⁻¹) but the difference between linear expansion coefficients of a CFRP material (0.1×10⁻⁵K⁻¹) and a 64Ti alloy (0.8×10⁻⁵K⁻¹) becomes less than a half thereof.

In the next, it can be understood that the most awkward problem in promoting assembly of joining a CFRP plate with a 64Ti alloy with adhesive in a manner of the invention disclosed in Patent Document 12 consists in a step of overlaying thick adhesive. It is considered that plurality of elongated CFRP plates extend from the central portion of the wing towards periphery of the base portion of the main wing to the central portion of the body. A 64Ti alloy plate must be joined with each of the CFRP plates by adhesion to be a pair joined by adhesion. As to how about area of adhesion in which adhesive is overlayed onto each of paired plates, calculating the area by supposing simply the area of adhesion to be 200 mm×200 mm, the area is 400 cm². The commercially available adhesive “EW2040” explained above is used, which is overlayed onto the 64Ti alloy side as it is. For the other CFRP plate side, adhesive is overlayed first onto an Al alloy A6061 sheet and onto the surface of a CFRP for a wide area of, for example by 600 cm², and both of these are joined each other by NAT type adhesion to be finished. After this, adhesive is overlayed on the Al alloy sheet side of the integrated article of the CFRP and Al alloy A6061 sheet for a face of 400 cm², and then adhesion is conducted by attaching the faces with adhesive overlayed closely each other. Here, it is necessary to make the layer of adhesive have an expected thickness. It is good to calculate this according to the method described in the invention of Patent Document 12. In this, if adhesive needs thickness of at least 3 mm for 400 cm² of 200 mm×200 mm by trial calculation, working for its assembly becomes difficult and cannot avoid much problems. While the invention in Patent Document 12 presents a method of forming a pool shaped article with upper side open for holding the adhesive on the plate and pouring adhesive therein, there is a problem in easiness of working here. In actual working place of adhesion where it is common to make adhesive layer thin, techniques of making adhesive layer thick in a planned manner is not one by a traditional craftsman. The inventor does not find a method other than one described in Patent Document 12, which may not be smart one in any way and one not satisfying the inventor.

Second of the problems concerns selection of adhesive itself. This is a question whether the adhesive may be limited to the two kinds of adhesive decided only by data of performance competition among pairs joined by adhesion of Al alloy A7075 under condition of solidification of adhesive of 150° C.×20 minutes, that is, the adhesive No. 4 in Table 2 in Patent Document 8 and “EW2040” found among commercially available adhesives. In short, adhesion by the present invention is one that joins different kinds of materials each other in a manner that the materials sandwich a thick layer of hardened adhesive having a thickness of 1 to several mm, providing a structure by adhesion for perfectly fixing a whole structure. It should be considered also before designing the structure as to how about the integrated structural article joined by adhesion exhibits performance of shear joining strength. In order to solve this problem, a hardened adhesive itself of 20 mm×15 mm×thickness of 4 mm is prepared, with which a test piece as shown in FIG. 9 is prepared, and strength test was conducted for this. The layer of hardened adhesive is attached to a concave formed on one end of the Al alloy A7075 plate on the left side in FIG. 9 by adhesion.

In this, the surface of the hardened adhesive layer is polished with sandpaper (dotted area) and the hardened adhesive layer is attached to the concave of the Al alloy plate having been subjected to NAT treatment by adhesion. After this, the upper end portion of the hardened adhesive is polished with sandpaper and adhesive “EW2040” is overlayed thereon. In a similar manner, adhesive “EW2040” is overlayed also on the underside face of Al alloy A7075 plate having been subjected to NAT treatment (the upper of the hardened adhesive and right side member as shown). The left side plate, the hardened adhesive and the right-side Al alloy A7075 are laminated and joined by adhesion. In this situation, these are fixed with a jig for fixing such as a clip (in a situation of the pair joined by adhesion shown in FIG. 9). Placing the pair joined by adhesion and fixed with a jig as a clip in vacuum circumference and returning to an ordinary pressure, repeating such operation, the pair is finished by heating it at a temperature of 150° C. for 20 minutes. In short, regarding the hardened adhesive itself as one of high strength members in a similar manner for a CFRP material or a metal alloy material, the pair joined by adhesion of this hardened adhesive with an Al alloy A7075 material was prepared and shear joining strength thereof was measured. This is a method for measuring shear joining strength by adhesion of a hardened adhesive as a kind of formed thermosetting resin article with an ultra-super duralumin material (Al alloy A7075).

While the present inventor planned experiment shown in FIG. 9 by measuring physical property of a lump of adhesive having been solidified under 150° C.×20 minutes, this plan was stopped after all. The reason for stopping the plan is that the experiment itself is test of tensile joining strength by adhesion of the joined article by adhesion shown in FIG. 5 and test of joining strength under shear stress and tensile stress and both was decided to be of substantially same test of joining strength by adhesion, though different strictly speaking. In short, in test of tensile joining strength of articles of test pieces shown in FIG. 5 of metal alloy materials having been subjected to NAT treatment joined each other by adhesion, tensile joining strength of almost of all test pieces was 60 to 70 MPa for any selected kind of metal material and for some kinds metal materials it was 80 to 90 MPa. Thus, tensile joining strength by adhesion of pairs of same kind of metal materials was equivalent to shear joining strength thereof or more. Seeing the test piece for a tensile test shown in FIG. 5 recognizing it, hardened adhesive itself is sandwiched between the end portions of the metal alloy plates and endured tensile breaking force even though it is in shape of a thin sheet having an area of 0.27 cm² and a thickness of 0.1 to 0.3 mm.

Tensile strength of this adhesive itself, that is, hardened adhesive “EW2040” itself is very high as decided from the above data to be about 90 MPa to 100 MPa or more. Due to this, it is decided that this kind of adhesive is suitable for use in the present invention. It is confirmed specifically that selection of one part epoxy adhesive of adhesive No. 4 in Table 2 in Patent Document 8 and adhesive “EW2040”, etc., was right. Of course, even if thickness of hardened adhesive becomes thick to a level of several mm, basic performance itself as adhesive does not change compared with one by adhesive having a thickness in a level of 0.1 mm. Here, it is natural that as hardened adhesive becomes thicker its transformation due to load becomes larger, so that thickness is limited in designing a structure by adhesion.

To say further, being similar as explained above, in a case of a pair of materials both having high strength and having a large difference of linear expansion coefficients between them joined each other, deviation in shape of face of adhesion between them is created when the pair is exposed to lower temperature, so that shape of hexahedron changes for a hardened adhesive in a plate shape. Such transformation corresponds to one that shaped articles similar to a cylindrical, cubic or rectangular body becomes similar to pedestal cone, trapezoidal platform shaped body. Thus, while, with a height of the trapezoid, that is, thickness of the hardened adhesive of about 0.1 mm, the hardened adhesive having area of adhesion in a level of 0.5 to 0.6 cm² will be broken, hardened adhesive having thickness no less than 2 to 4 mm may endure even with area of adhesion of 400 cm². While transformation of hardened adhesive corresponding to load can be obtained in design of machine by simulation, etc., at present, experiment is necessary in view of safety. It is good to find problems, even though by a few, in nondestructive test, for example, 3000 cycle test of +150° C./−50° C. thermal shock for an integrated article finished as a product. For such test of durability, thickness of hardened adhesive may be 5 mm, or may remain to 3 mm with area of adhesion decreased to half. If number of pairs of a CFRP material with a 64Ti alloy material becomes twice compared with corresponding CFRP material, number of strengthened 64Ti alloy plates becomes twice. Here, even if number of these increases, main portion thereof is a plate made of Al alloy, so that there occurs no problem by joining with bolt-nut at two sites. The present invention provides an answer to a main concern for hardened adhesive, that is, “Is there true meaning in increasing thickness to be several mm?”

In this, at the time when the present inventor decided the adhesive No. 4 in Table 2 in Patent Document 8 to be most suitable one, measurement of its performance was not conducted for its performance in a case where state of the adhesive under an ordinary temperature is solid. This is because if the adhesive is dissolved in a container requiring no working for overlaying to use as adhesive and then solidified under 150° C. and the solidified is used as an object article, adhesive for such use does not require necessarily to be in a state of liquid or paste. Even if adhesive is solid at an ordinary temperature, it would be possible to conduct test of shear joining strength by adhesion through changing condition of temperature. However, it was not confirmed.

Actually, experimental data described in Patent Document 8 is specifically one for one part epoxy resin adhesive as an object of experiment and it is decided that adhesive of liquid state, paste state, etc., to be used for adhesion step is selected at a manufacturing floor of a passenger airplane, etc., as such the data was decided to be open in the Document. Therefore, while this is precise as data, it does not extend sufficiently to solid state adhesive. As there was some information such that solid state one part epoxy resin adhesive is necessary in producing matrix resin necessary for producing CFRP prepregs as an application of the adhesive, data thereof were written, though a few, on the invention notebook of the present inventor. The data is described in the Embodiment 3 below in the specification. In any way, while there is no application directly using hardened adhesive thicker than a certain thickness anywhere, at that time or at present, the present inventor came to notice for the first time in this invention that this hardened adhesive in a shape of thick plate is an important article with application.

In joining Al alloy A6061 material with linear expansion coefficient of 2.3×10⁻⁵K⁻¹ and 64Ti alloy plate with linear expansion coefficient of 0.8×10⁻⁵K⁻¹ with adhesive, thickness of adhesive is made thick as of several mm. At first, one part epoxy resin adhesives in solid state at an ordinary temperature other than “EW2040” and adhesive No. 4 in Table 2 in Patent Document 8 as explained above are added to suggestions for study. Then, the adhesives are made to have a plate shaped article and hardened by heating at a temperature of 150° C., after which working for roughening the surface thereof with sandpaper, etc., to be surface having fine irregularities. Adhesive “EW2040” is overlayed onto both faces of the plate shaped article and the adhesive is overlayed also onto surface of each of an Al alloy A6061 sheet and a 64Ti alloy plate having been subjected to NAT treatment. Then, the Al alloy A6061 sheet, the above plate shaped article of adhesive and a 64Ti alloy plate are laminated, and these are joined one another with adhesive to be hardened. By joining with adhesive all the faces to be joined in such a manner, all parts, from CFRP material to 64Ti alloy material, can be integrated without awkward and difficult adhesion operation. For adhesion of an Al alloy A6061 material and a 64Ti alloy material, an article of different kinds of materials joined by adhesion each other can be prepared by sandwiching a layer of hardened adhesive prepared in another step. A method for securing a thickness of 1 to several mm of hardened adhesive layer to be sandwiched between materials having a large difference of linear expansion coefficient has been found out for the first time.

To say simply, while adhesive in liquid state or paste state is used easily when adhesion for a large-scale structure is conducted at a wide assembly work site, adhesive in solid state is used in the present invention. Unless at an assembly work site, work of adhesion can be conducted with any adhesive including one in solid state. For solidifying adhesive, the adhesive is once dissolved to be liquid state, put into a container, etc., and solidified by heating to have a desired shape. Fine irregularities are formed on the surface thereof by some way providing such fine irregularities as a result, which may be mechanical working with sandpaper, by grinding or others. The face with fine irregularities is cleaned with cleaning water, wind, etc., after working thereof. The hardened adhesive is specified as an intermediate material used for joining step by adhesion. In a case of afterward joining of large size members, heavy members, etc., by adhesion, only by bringing this intermediate material into an adhesion operation site, it is easy to join members, even if of different kinds, by adhesion using this hardened adhesive along with adhesive in a liquid state or paste state. Therefore, at an assembly site of an airplane, for example, the above explained plate shaped hardened adhesive is prepared using suitable adhesive at another site apart from the assembly site and it is used as a material for adhesion step, or to say as “hardened adhesive used for connection”. As this hardened adhesive can be stored for a certain while, it becomes an important factor of rationalization for a firm producing airplanes, with which operators at a work site can conduct smooth operation without lowering operation efficiency.

Then, the adhesive itself used for joining this “hardened adhesive used for connection” with a structural member by adhesion may be one in liquid state, paste state or solid state, for a person studying adhesive or an engineer improving adhesive. This was surely one that the present inventor lacked. In this, it is producers of CFRP prepregs at present that mainly produce adhesive not in liquid state or paste state but in solid state and, as such producers use one part epoxy resin adhesive in solid state at an ordinary temperature, there is sufficient possibility of obtaining most suitable adhesive for use as “hardened adhesive used for connection” under cooperative study with a CFRP producer.

As summary of the aforementioned, this adhesive in solid state can be used for joining structural members by adhesion, for example, ones of B787 (model designation) produced by an airplane producer in USA. This is for joining an Al alloy A7075 portion set to the central portion of body as a most important skeleton member with a CFRP plate portion set to the base portion of a main wing. It is desired to employ a method of joining both members by adhesion of NAT type in place of a method of joining with rivets made of Ti alloy. Also, it is required to further basically improve the invention disclosed in Patent Document 12 as a prior invention. Thus, problems to be solved the present invention is as follows.

The present invention presents an integrated article of a metal material for structure with a CFRP plate material joined by adhesion and a method for assembling the same, in which a metal material for structure and a CFRP plate material can be joined to be integrated with adhesive.

The present invention further presents an integrated article of a metal material for structure with a CFRP, in which a metal material for structure and a CFRP plate material are joined to be integrated by adhesion with a hardened thermosetting adhesive as a buffer material intervening between them.

### Means for Solving the Problems

The present invention is provided with the following means.

An integrated article by adhesion of a metal alloy material for structure with a CFRP material according to the present invention 1 is one in which a metal plate material is integrated with a CFRP plate material with adhesive, and comprises:
a CFRP plate material and a metal alloy plate material, in which one face of the metal plate material is joined by adhesion with thermosetting adhesive to the CFRP plate material to be integrated,
a hardened adhesive in which one face of the hardened adhesive is joined by adhesion with the thermosetting adhesive to the other face of the metal plate material for an area narrower than the one face of the metal plate material and the thermosetting adhesive is cured by heating, and
an intermediate material joined by adhesion with the thermosetting adhesive to the other face of the hardened adhesive.

The integrated article by adhesion of a metal alloy material for structure with a CFRP material according to the present invention 2 is characterized in that, in the present invention 1,
the metal alloy plate material is an aluminum alloy plate material,
the hardened adhesive has no less than one uniform plate shaped thickness, and
the intermediate material is a Ti alloy material.

The integrated article by adhesion of a metal alloy material for structure with a CFRP material according to the present invention 3 is characterized in that, in the present invention 2,
the hardened adhesive is one part epoxy resin adhesive,
the metal alloy plate material is an aluminum alloy A6061 by JIS,
the metal alloy material for structure is an aluminum alloy of a type Al—Zn—Mg—Cu, and
the Ti alloy material is of “JIS60 species” and fastened to the metal alloy material by mechanical fixing means.

A method for assembling the integrated article by adhesion of a metal alloy material for structure with a CFRP material according to the present invention 4 is characterized in that, for the integrated article by adhesion of a metal alloy material for structure with a CFRP material according to the present invention 2, the method comprises:
a step of forming faces with fine irregularities by forming faces with fine irregularities on the one face and the other face of the CFRP plate material and the aluminum alloy plate by chemical treatment or mechanical working before adhesion of the CFRP plate material with the aluminum alloy plate material,
a step of joining the CFRP plate material with the aluminum alloy by adhesion,
a step of working on the front and backside faces of the hardened adhesive by forming faces with fine irregularities on one face and the other face as front face and backside face of the hardened adhesive by mechanical working, and
a step of joining Ti alloy material by adhesion of joining the one face of the hardened adhesive onto the other face of the aluminum alloy plate by adhesion with the thermoplastic adhesive and joining the Ti alloy material onto the other face of the hardened adhesive by adhesion with the thermosetting adhesive.

The method for assembling the integrated article by adhesion of a metal alloy material for structure with a CFRP material according to the present invention 5 is characterized in that, in the present invention 4,
the step of joining by adhesion of joining the CFRP plate material with the aluminum alloy by adhesion and the step of joining Ti alloy material by adhesion are conducted in a decompressed circumference.

### (Hardened Adhesive)

The above hardened adhesive can be said as to be an intermediate material between a metal alloy material for structure with a CFRP plate material joined by adhesion in a mechanical structure consisting of a metal material alloy material for structure, a CFRP plate material, etc. The hardened adhesive has a function of absorbing thermal transformation due to difference of thermal expansion of the metal material alloy material for structure, the CFRP plate material, etc., when the mechanical structure is heated or cooled under change of circumference. Further, the hardened adhesive is also a buffer material for catching load within a range of allowable elastic transformation when load has been given on the mechanical structure.

### BRIEF DESCRIPTION OF DRAWINGS

FIG. 1 is a perspective view showing a test piece for measuring shear breaking strength between metal-resin as an integrated article joined by injection molding in which thermoplastic resin is injected into a metallic mold in which a metal alloy piece having been subjected to NMT treatment has been inserted.

FIG. 2 is a cross-sectional view showing an auxiliary jig used for setting the test piece on a tensile test machine.

FIG. 3 is a perspective view showing a test piece for measuring tensile breaking strength between metal-resin as an integrated article joined by injection molding in which thermoplastic resin is injected into a metallic mold in which a metal alloy piece having been subjected to NMT treatment has been inserted.

FIGS. 4A and 4B are perspective views showing test pieces for measuring shear joining strength by adhesion of hard material pieces each other as integrated articles joined by adhesion of metal pieces each other, a metal piece with a CFRP piece, a metal piece and hard material piece such as a thermosetting resin piece each other.

FIG. 5 is a perspective view showing a test piece for measuring tensile joining strength by adhesion of hard material pieces each other as integrated articles joined by adhesion of metal pieces each other, a metal piece with a CFRP piece, a metal piece and hard material piece such as a thermosetting resin piece each other.

FIG. 6A is a cross-sectional view showing a state of where a CFRP plate and an Al alloy A6061 sheet are joined by NAT type adhesion of dry adhesion method or wet adhesion method, FIG. 6B is a cross-sectional view showing a state where a plate-shaped member of hardened adhesive formed in another method with both of upper and lower faces having been subjected to treatment of forming fine irregularities and a 64Ti alloy plate having been subjected to NAT treatment are added to the prepared in the previous step and necessary faces of these are overlayed with adhesive to be prepared for another step, and FIG. 6C is a view showing a state where all joining by adhesion is performed and the 64 Ti alloy plate and an Al alloy A7075 portion as a skeleton of a structural article are connected with bolt-nut.

FIGS. 7A to 7D are views showing an example of a method of joining by adhesion of a CFRP plate, an Al alloy A6061 sheet, a hardened adhesive article and a Ti alloy material, laminating these, in which FIG. 7A is a cross-sectional view showing a state where a CFRP plate and an Al alloy A6061 sheet are joined by adhesion and necessary hardened adhesive is prepared with treatment of forming fine irregularities on the surface applied, FIG. 7B is a cross-sectional view showing a state where the hardened adhesive has been joined by adhesion with the integrated article prepared in the previous step, FIG. 7C is a cross-sectional view showing a state where a 64Ti alloy material is prepared additionally with the integrated article prepared in the previous step, and FIG. 7D is a cross-sectional view showing a state where 64Ti alloy material has been joined by adhesion with the integrated article prepared in the previous step.

FIGS. 8A to 8D are views showing another example of a method of joining by adhesion of a CFRP plate, an Al alloy A6061 sheet, a hardened adhesive article and a 64Ti alloy material, laminating these, in which FIG. 8A is a cross-sectional view showing a state where a CFRP plate and an Al alloy A6061 sheet has been joined by adhesion, FIG. 8B is a cross-sectional view showing a state where the hardened adhesive with necessary treatment of forming fine irregularities on the surface applied is joined by adhesion with the 64Ti alloy material having been subjected to NAT treatment to be integrated, FIG. 8C is a cross-sectional view showing a state where the integrated article of the 64Ti alloy material with the hardened adhesive is prepared in reversed state additionally to the integrated article of the CFRP plate with the Al alloy A6061 sheet prepared in the previous step, and FIG. 8D is a cross-sectional view showing a state where both parts have been joined by adhesion.

FIG. 9 is a perspective view showing a test piece for measuring shear joining strength of a joined article by adhesion in which a thermosetting resin piece covered with a worked article of Al alloy A 7075 and a metal piece joined by NAT type adhesion and a metal piece are joined with adhesive.

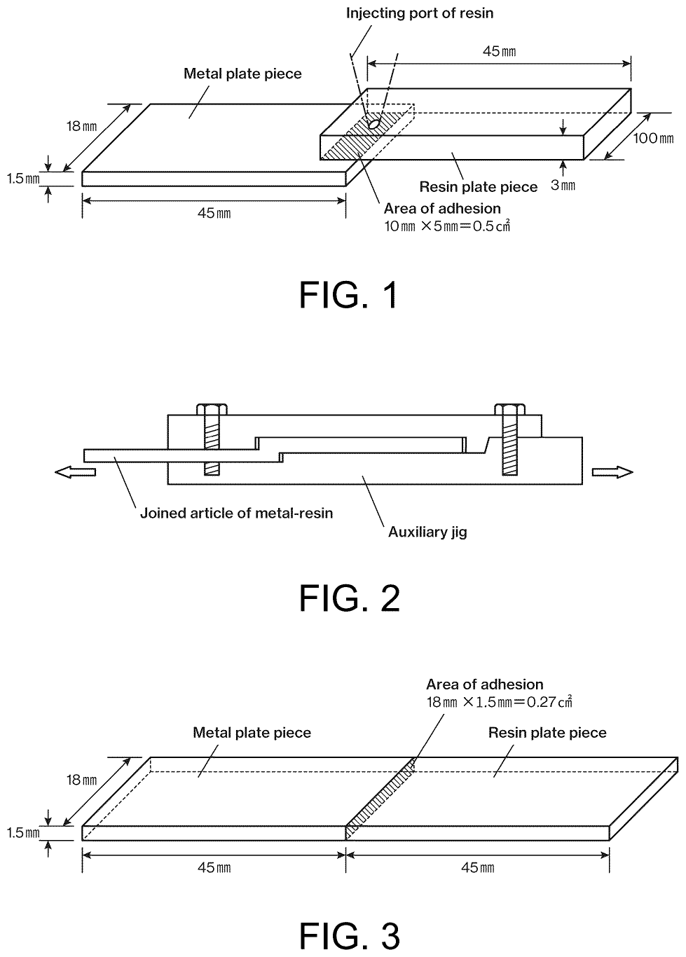

### DETAILED DESCRIPTION OF EMBODIMENTS

The integrated article of a metal alloy material with a CFRP material joined by adhesion and the method for assembling the same according to the present invention will be explained specifically on the basis of preferred embodiments below.

### Embodiments

### [Embodiment 1] NAT Treatment Method of Al Alloy A6061 (Named as Seventh Type of NAT Treatment Method)

Commercially available Al alloy A6061 pieces having a thickness of 0.5 mm (called also as “Al alloy pieces” below) were purchased to be test pieces. Tap water was made ready in a tank, into which commercially available degreaser for Al alloy “NE-6” (made by Meltex Co. Ltd.: main company in Tokyo, Japan) was taken in the aqueous solution to be aqueous solution with concentration of 7.5% at 60° C. The above Al alloy pieces in a rectangular shape were immersed in the aqueous solution for 7 minutes, and after then the pieces were well rinsed with water. Pure water was used for treatment below. Next, an aqueous solution of hydrochloric acid having a concentration of 1% was made ready to be at 40° C. in another tank, in which the Al alloy pieces were immersed for 1 minute, and after then the pieces were well rinsed with water. Next, an aqueous solution of caustic soda having a concentration of 1.5% was made ready to be at 40° C. in still another tank, in which the Al alloy pieces were immersed for 4 minutes, and after then the Al alloy pieces were rinsed with water. Next, an aqueous solution of nitric acid having a concentration of 3% was made ready to be at 40° C. in still another tank, in which the Al alloy pieces were immersed for 3 minutes, and after then the Al alloy pieces were rinsed with water. Next, an aqueous solution of hydrazine hydrate having a concentration of 3.5% was made ready to be at 60° C. in still another tank, in which the Al alloy pieces were immersed for 1 minute, and then the Al alloy pieces were rinsed with water. Further, an aqueous solution of hydrazine hydrate having a concentration of 1.5% at 35° C. was made ready in still another tank, in which the Al alloy pieces were immersed for 5 minutes, after then the pieces were rinsed with water and then placed in a warm air drier set to be at a temperature of 67° C. for 15 minutes to be dried. After this, the Al alloy pieces were wrapped together with aluminum foil and the entered into a plastic bag and closed to be stored.

### [Embodiment 2] Method of NAT Treatment of 64Ti Alloy

Commercially available 64Ti alloy plates were purchased. An aqueous solution containing the above degreaser for Al alloy “NA-6” by 7.5% was made ready to be at 60° C. in a tank. The above 64Ti alloy plates were immersed for 5 minutes to be degreased, and after then the plates were well rinsed with water. Pure water was used below. Next, an aqueous solution containing ammonium hydrogen bifluoride by 1% and sulfuric acid by 10% was made ready to be at 62° C. in another tank, in which the 64Ti alloy plates were immersed for 6 minutes, and after then the 64Ti alloy plates were rinsed with water. Next, the 64Ti alloy plates were immersed in an aqueous solution containing nitric acid by 3% for 3 minutes, after which the 64Ti alloy plates were rinsed with well water. Next, the 64Ti alloy plates were immersed in an aqueous solution containing potassium permanganate by 2% and caustic potassium by 3% made ready to be 70° C. for 30 minutes and then rinsed with water. Next, the 64Ti alloy plates were immersed in an aqueous solution containing sodium chlorite by 5% and caustic soda by 10% made ready to be 55° C. for 15 minutes, after which the plates were rinsed with water and then placed in a warm air drier and dried for 15 minutes. After this, the 64 Ti alloy plates were wrapped together with aluminum foil and further entered into a plastic bag and closed to be stored.

### [Embodiment 3] Data for Preparation of One Part Epoxy Resin Adhesive and Measurement of Performance Thereof

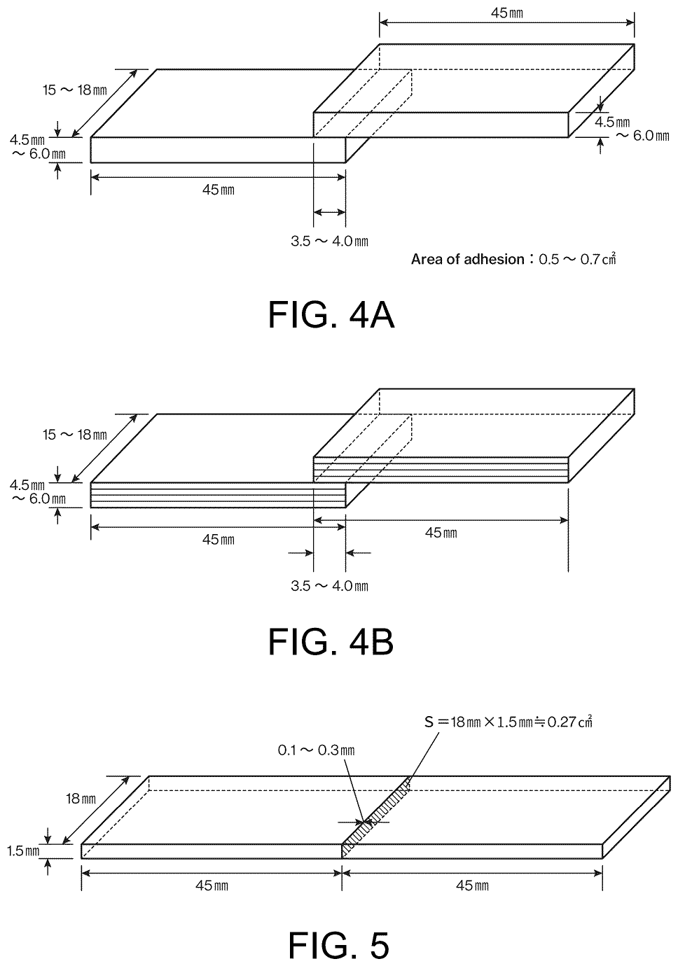

The adhesive disclosed in Patent Document 8 (invention by the present inventor) is used also in the embodiments of the present invention. Matters the present inventor conducted (experimented) several years before are described there along with data for preparation of one part epoxy resin adhesive. While the data in the present invention are basically same as ones in Patent Document 8, view and recognition of data are different between both. In such view point, the matters along with data are used for assistance also in the explanation of embodiments of the present invention. Pairs of Al alloy A7075 pieces (test pieces) having been subjected to NAT treatment joined by adhesion each other are used in the experiment of joining strength of adhesive, and the pairs joined by adhesion are articles in a shape shown in FIGS. 4A and 4B. Method of chemical treatment of the Al alloy A7075 pieces used there is one explained below.

Commercially available plates of Al alloy A7075 with thickness 3 mm were purchased and, cutting the plates, many Al alloy A7075 pieces in a shape of 45 mm×15 mm were prepared. Commercially available degreaser for Al alloy “NE-6” is added to water in a tank to be an aqueous solution with a concentration of 7.5% (at a temperature of 60° C.). The above A7075 pieces were immersed in this aqueous solution for 7 minutes and after then were rinsed well with water. Next, an aqueous solution of hydrochloric acid having a concentration of 1.0% was made ready (at a temperature of 40° C.) in another tank, in which the A7075 pieces were immersed for 1 minute, and after then the pieces were rinsed with water. Next, an aqueous solution of caustic soda having a concentration of 1.5% (at a temperature of 40° C.) was made ready in still another tank, in which the A7075 pieces were immersed for 4 minutes, and after then the pieces were well rinsed with water. Next, an aqueous solution of nitric acid having a concentration of 3.0% (at a temperature of 40° C.) was made ready in still another tank, in which the A7075 pieces were immersed for 1 minute, and after then the pieces were rinsed with water. Next, an aqueous solution containing hydrazine hydrate by 3.5% (at a temperature of 60° C.) was made ready to be at in still another tank, in which the A7075 pieces were immersed for 2 minutes, and after then the pieces were rinsed with water. Next, an aqueous solution of hydrogen peroxide water having a concentration of 5% (at a temperature of 25° C.) was made ready in still another tank, in which the A7075 pieces were immersed for 5 minutes, and after then the pieces were rinsed with water. Next, the Al alloy pieces were placed in a warm air drier set to be at a temperature of 67° C. for 15 minutes and dried there. Aside from these, A7075 pieces having been subjected to treatment quite same as the above were observed with an electron microscope, with which it was seen that surfaces thereof were covered with concaves having diameters of 40 to 100 nm. Regarding this, photographs with magnitude of 10 thousand times and 100 thousand times are shown in Patent Document 8. Further, RSm was 3˜4 μm and Rz was 1˜2 μm, as measured with a scanning probe microscope.

In the next, the method of preparing adhesive in Experimental Example 3 (Preparation of adhesive) of Patent Document 8 will be explained here.

Epoxy resin “JER828” containing epoxy resin of bisphenol A monomer as a main component (made by Mitsubishi Chemical Co., Ltd. (main company in Tokyo, Japan)) having a molecular weight of about 370, bisphenol novolac epoxy resin “JER1004” (made by Mitsubishi Chemical Co., Ltd.) of polymer in solid state having a molecular weight of about 1600, multi-sensitive phenol novolac epoxy resin “JER154” (made by Mitsubishi Chemical Co., Ltd.), 3 sensitive aniline epoxy resin “JER630” (made by Mitsubishi Chemical Co. Ltd.), PES powder “PES4100MP” (made by Sumitomo Chemical Co., Ltd. (main company in Tokyo, Japan)) having average particle size of about ten and several μm, pure aluminum alloy powder “Aluminum Powder for Filler” (made by Toyo Aluminum Co., Ltd. (main company in Osaka, Japan)) having center of particle size distribution in 10 μm, fine powder talc “Hi Micron HE5” (made by Takehara Chemical Co., Ltd. (main company in Hyogo, Japan)) and clay (kaolin) “Satenton 5” (made by Takehara Chemical Co., Ltd.) having particle size equivalent to that, multilayer type carbon nanotube “MCNT” (made by Nano Carbon Technologies Co., Ltd. (Tokyo, Japan)) having diameter of about 50 nm, fumed silica “Aerosil R805” (made by Japan Aerosil Co., Ltd. (main company in Tokyo, Japan)), fine powder dicyandiamide “DICY7” (made by Mitsubishi Chemical Co. Ltd.) as hardener of epoxy resin, fine powder of 2-methylimidazole “2 MI” (made by Nippon Synthetic Chemical Industry Co., Ltd. (main company in Tokyo, Japan)), granule of 2-phenylimidazole “2PI” (made by Nippon Synthetic Chemical Industry Co., Ltd.), N,N′-dimethylpiperazine “Dimethylpiperazine” (made by Showa Chemical Industry Co., Ltd. (main company in Tokyo, Japan)) and fine powder of 3-(3,4-dichlorophenyl)-1,1-dimethylurea “DCMU99” (Hodogaya Chemical Co., ltd. (main company in Tokyo, Japan)) were purchased. In this, as “2PI”, among the above purchased drugs, was not powder but granule, 200 g of it was placed into a ceramic ball mill having a diameter of 150 mm to be pulverized for 30 minutes, and then the pulverized was sieved. Further, one having passed through 300 mesh was stored and used as powder “2PI”.

Further, composition of epoxy resin and characteristics of adhesive are disclosed in Patent Document 8, and summery thereof will be described for explanation of embodiments of the present invention below.

### (Composition of Epoxy Resin)

Viscosity of the following four kinds of epoxy resin (1)˜(4), that is, (1) JER630, (2) JER1004, (3) JER154 and (4) JER630 will be explained.

Of the four, (1) JER 828 and (4) JER630 are of low viscosity. On the other hand, (2) JER1004 is in solid state. Further, while (3) JER154 is in liquid state and of high viscosity at a temperature of 30° C.˜40° C., it is near to be in solid state at a room temperature below 20° C. As such, ones having low viscosity are (1), (4), ones having high viscosity are (2) and (3). These epoxy resins are taken into a large beaker, melted by heating and homogenized by mixing well. Then, the mixture is left cooled to be a state of lowered temperature of about 25° C. In order to use the mixture as a main liquid of one epoxy resin adhesive, it is necessary at least that it is a liquid material in this state.

Ingredient ratio of each epoxy resin will be explained in detail. It is taken as that the above (1) is a parts by mass, the above (2) is b parts by mass, the above (3) is c parts by mass and the above (4) is d parts by mass among total epoxy resin 100 parts by mass composing one part epoxy adhesive. That is, it is taken as that a+b+c+d=100 parts by mass. If mass of the above (2) and (3) having high viscosity is over 32 parts by mass, the mixture becomes one having high viscosity or solid state one, difficult for dealing with at an ordinary temperature. Here, as it is necessary to add the above (2) and (3), condition of lower limit for mixing is prescribed such that 32≥b+c≥5 (or 95=a+d≥68). Also, it is desired to add the above ingredients (3) and (4), being polyfunctional epoxy resin considered to keep hardness and to strengthen the mixture as a whole at high a temperature, by a large amount. In this, when these are added too much, the mixture becomes brittle at an ordinary temperature and rather its strength of adhesion is lowered. As such, condition of mixing “c+d” is taken as to be 32≥c+d≥15. Further, while the above ingredient (2) lowering hardness and raising toughness is necessary for keeping strength of adhesion at an ordinary temperature, adding it too much lowers strength of adhesion at a high temperature. As such, ingredient of “b” is taken as to be 22≥b≥5.

Here, regarding the above ingredients (3) and (4), being polyfunctional epoxy resin, while the above (3) having composition of phenol resin is mainly used usually, the above (3) is of high viscosity so that the above (4) is used here in place thereof. As a result of experiment by the present inventor, et al., it was found that sufficient heat resistance can be attained even if the above (4) being of simple shape is used in place thereof. As it was confirmed at least from the result of the experiment that the above (4) has no problem in heat resistance, it is taken as that d≥7, considering use of the above (4) of low viscosity more than a certain amount. As a conclusion, relation of a, b, c, and d, supposing a+b+c+d=100 parts by mass, becomes as follows.

$$95 ≧ a + d ≧ 68 \qquad Eq . ( i )$$

$$32 ≧ c + d ≧ 15 \qquad Eq . ( ii )$$

$$22 ≧ b ≧ 5 \qquad Eq . ( iii )$$

$$d ≧ 7 \qquad Eq . ( iv )$$

The above Eqs. (i) to (iv) are applied in a case where hardener is powder of dicyandiamide, and auxiliary agent of hardener is 2-phenylimidazole or 3-(3,4-dichlorophenyl)-1,1-dimethylurea. In a case where auxiliary agent of hardener is 2-methylimidazole or N,N′-dimethylpiperazine, the following Eqs. (v) to (viiii) are applied.

$$95 ≧ a + d ≧ 68 \qquad Eq . ( v )$$

$$30 ≧ c + d ≧ 18 \qquad Eq . ( ii )$$

$$22 ≧ b ≧ 5 \qquad Eq . ( iii )$$

$$d ≧ 10 \qquad Eq . ( iv )$$

The values in the above Eqs. are a basis for securing viscosity necessary for use as adhesive along with securing strength of adhesion and heat resistance. After having decided hardener and auxiliary agent of hardener to be used, epoxy resin is prepared according to either of the above Eqs. (i) to (iv) or Eqs. (v) to (viii). After this, adding filler and then further adding hardener and auxiliary agent of hardener, one part epoxy adhesive is prepared. In Experimental Example 3 of Patent Document 8, preparation of adhesive 1 (A, PES, DICY, 2PI) is explained on the basis of such relation of composition of epoxy resin with characteristics of adhesive. That is, taking masses of JER828, JER1004, JER154 and JER630 as a, b, c and d, respectively, 60 parts by mass of JER828, 10 parts by mass of JER1004, 20 parts by mass of JER154 and 10 parts by mass of JER630 are taken into a beaker, left heated in a hot air drier set to be at temperature of 165° C., stirred well at the same time when solid state JER1004 is melted and homogenized as a whole. The resulting is left cooled and then stored as epoxy resin liquid. In this case, a=60, b=10, c=20 and d=10, so a+b+c+d=100 parts by mass. As a+d=70 at this time, conditions of both of the above Eq. (i) and Eq. (v) are satisfied. Further, as c+d=30, conditions of both of the above Eq. (ii) and Eq. (vi) are satisfied. Furthermore, as b=10, conditions of both of the above Eq. (iii) and Eq. (vii) are satisfied. Still furthermore, as d=10, conditions of both of the above Eq. (iv) and Eq. (viii) are satisfied.

Further, as explained later, considering that requirement in a case where 2-phenylimidazole or 3-(3,4-dichlorophenyl)-1,1-dimethylurea is used as auxiliary agent of hardener (in a case where Eqs. (i) to (iv) are applied) is satisfied and also requirement in a case where 2-methylimidazole or N,N′-dimethylpiperazine is used as auxiliary agent of hardener (in a case where Eqs. (v) to (viii) are applied) is satisfied, a sand grind mill “Tsuea” (made by Ashizawa Finetec Co/Ltd. (main company in Chiba, Japan)) having zirconia beads with diameter of 0.3 mm filled in the grinding chamber by 80% of its capacity was made ready and a circulation pump and an open tank equipped with a mixer were connected to the inlet port side thereof. On the other hand, the outlet port of the sand grind mill was left open to an open tank. The above epoxy resin liquid was reheated to be 60° C. with viscosity lowered, 100 parts by mass (400 g) thereof was taken into the open tank and the grinding chamber was filled completely by the circulation pump, after which operation of the above sand grind mill was started. As the sand grind mill has water cooling line, water flow therethrough was adjusted so as to keep temperature within the grinding chamber to be 50° C.˜60° C. Peripheral speed of the mill rotor was set to be 11˜12 m/second.

Further, 0.5 parts by mass (2 g) of fumed silica “Aerosil R805” was taken into the open tank to promote circulatory grinding, then 3 parts by mass (12 g) of fine powder talc “Hi Micron HE5” was taken thereinto to promote circulatory grinding, then 4 parts by mass (16 g) of PES powder “PES4100M” was added thereto gradually, after which wet grinding (substantially operation of dispersing filler in the epoxy resin liquid) was continued for 60 minutes. After this, by changing direction of the outlet port of the sand grind mill from the open tank to a polyethylene bottle, so that mixture was stored in the polyethylene bottle. 107.5 parts by mass of this mixture contains 100 parts by mass of epoxy resin, 3 parts by mass of inorganic filler “Hi Micron HE5”, 0.5 parts by mass of ultrafine inorganic filler “Aerosil R805” and 4 parts by mass of thermoplastic resin powder “PES4100MP”. In the next, 107.5 parts by mass of the above mixture, 4.5 parts by mass of fine powder dicyandiamide “DICY7” as hardener and 2.25 parts by mass of powder of 2-phenylimidazole powder “2PI” as auxiliary agent of hardener were taken into a mortar. This mortar was placed into a warm air drier set to be at temperature of 40° C. and warmed for 30 minutes, after which the mixture was kneaded well with a pestle. This mixture was taken into a polyethylene bottle and left placed in a room all day for aging, after which it was stored in a refrigerator set to be 5° C. This adhesive is named as adhesive 1 (A, PES, DICY, 2PI).

As a result, these prepared adhesives were put in order and Nos. and composition of prepared adhesives were summarized in the following Tables 1˜3.

TABLE 1

| | | | | | | | Ultrafine | | | | |
|---|---|---|---|---|---|---|---|---|---|---|---|
| | | | | | | Inorganic | inorganic | | Thermo | | Auxiliary |
| Experi- | | | | | | filler | filler | Carbon | plastic | | agent of |
| menta | | Epoxy resin | | | | Himicron | Aerosil | nanotube | resin powder | Hardener | hardener |
| example | Adhesive | JER828 | JER1004 | JER154 | JER630 | HE5 | R805 | MCNT | PES4100MP | DICY7 | 2PI |
| 3 | 1 | 60 | 10 | 20 | 10 | 3 | 0.5 | — | 4 | 4.5 | 2.25 |
| 4 | 2 | 58 | 14 | 7 | 21 | 3 | 0.5 | — | 4 | 4.5 | 2.25 |
| 5 | 3 | 71 | 4 | 10 | 15 | 3 | 0.5 | — | 4 | 4.5 | 2.25 |
| 6 | 4 | 62 | 15 | 8 | 15 | 3 | 0.5 | — | 4 | 4.5 | 2.25 |
| 7 | 5 | 60 | 15 | 12 | 13 | 3 | 0.5 | — | 4 | 4.5 | 2.25 |
| 8 | 6 | 55 | 20 | 10 | 15 | 3 | 0.5 | — | 4 | 4.5 | 2.25 |
| 9 | 7 | 55 | 20 | 15 | 10 | 3 | 0.5 | — | 4 | 4.5 | 2.25 |
| 10 | 8 | 60 | 18 | 12 | 10 | 3 | 0.5 | — | 4 | 4.5 | 2.25 |
| 11 | 9 | 60 | 20 | 15 | 5 | 3 | 0.5 | — | 4 | 4.5 | 2.25 |
| 12 | 10 | 62 | 15 | 8 | 15 | 3 | 0.5 | — | 4 | 4.5 | 2.25 |
| 13 | 11 | 60 | 20 | 10 | 10 | 3 | 0.5 | — | 4 | 4.5 | 2.25 |
| 14 | 12 | 67 | 17 | 0 | 16 | 3 | 0.5 | — | 4 | 4.5 | 2.25 |
| 15 | 13 | 67 | 17 | 8 | 8 | 3 | 0.5 | — | 4 | 4.5 | 2.25 |
| 16 | 14 | 67 | 17 | 16 | 0 | 3 | 0.5 | — | 4 | 4.5 | 2.25 |
| 17 | 15 | 60 | 25 | 8 | 7 | 3 | 0.5 | — | 4 | 4.5 | 2.25 |
| 18 | 16 | 60 | 29 | 1 | 10 | 3 | 0.5 | — | 4 | 4.5 | 2.25 |

TABLE 2

| | | | | | | | Equation | | | |
|---|---|---|---|---|---|---|---|---|---|---|
| Experi- | | | | | | State at | of | Shear breaking atrength (Mpa) | | |
| mental | | Epoxy resin | | | | ordinary | condition | Ordinary | | |
| example | Adhesive | a | b | c | d | temperature | (i)~(iv) | temperature | 100° C. | 150° C. |
| 19 | 1 | 60 | 10 | 20 | 10 | High viscosity | ◯ | 62.8 | 43.3 | 38.0 |
| 20 | 2 | 58 | 14 | 7 | 21 | | ◯ | 71.2 | 57.8 | 42.1 |
| 21 | 3 | 71 | 4 | 10 | 15 | | X | 50.2 | — | — |
| 22 | 4 | 62 | 15 | 8 | 15 | | ◯ | 67.5 | 55.5 | 44.3 |
| 23 | 5 | 60 | 15 | 12 | 13 | | ◯ | 73.1 | 51.8 | 41.7 |
| 24 | 6 | 55 | 20 | 10 | 15 | | ◯ | 55.8 | 51.9 | 37.1 |
| 25 | 7 | 55 | 20 | 15 | 10 | Solid | X | — | — | — |
| 26 | 8 | 60 | 18 | 12 | 10 | | ◯ | 72.8 | 50.3 | 37.7 |
| 27 | 9 | 60 | 20 | 15 | 5 | Solid | X | — | — | — |
| 28 | 10 | 62 | 15 | 8 | 15 | | ◯ | 73.5 | 42.5 | 42.2 |
| 29 | 11 | 60 | 20 | 10 | 10 | High viscosity | ◯ | 64.2 | 51.5 | 33.1 |
| 30 | 12 | 67 | 17 | 0 | 16 | | ◯ | 72.8 | 50.6 | 38.3 |
| 31 | 13 | 67 | 17 | 8 | 8 | | ◯ | 69.5 | 49.8 | 35.5 |
| 32 | 14 | 67 | 17 | 16 | 0 | High viscosity | X | 64.0 | — | 27.1 |
| 33 | 15 | 60 | 25 | 8 | 7 | Solid | X | 70.0 | — | 26.5 |
| 34 | 16 | 60 | 29 | 1 | 10 | High viscosity | X | 62.3 | — | 23.9 |

TABLE 3

| | | | | | | | Ultrafine | | Thermo | | |
|---|---|---|---|---|---|---|---|---|---|---|---|
| | | | | | | Inorganic | inorganic | | plastic | | Auxiliary |
| Experi- | | | | | | filler | filler | Carbon | resin | | agent of |
| mental | | Epoxy resin | | | | Himicron | Aerosil | nanotube | powder | Hardener | hardener |
| example | Adhesive | JER828 | JER1004 | JER154 | JER630 | HE5 | R805 | MCNT | PES4100MP | DICY7 | 2PI |
| 6 | 4 | 62 | 15 | 8 | 15 | 3 | 0.5 | — | 4 | 4.5 | 2.25 |
| 35 | 17 | 62 | 15 | 8 | 15 | 3 | 0.5 | 0.1 | 4 | 4.5 | 2.25 |
| 36 | 18 | 62 | 15 | 8 | 15 | 3 | 0.5 | — | — | 4.5 | 2.25 |
| 37 | 19 | 62 | 15 | 8 | 15 | 3 | — | — | 4 | 4.5 | 2.25 |
| 38 | 20 | 62 | 15 | 8 | 15 | 3 | 0.5 | — | 4 | 4.5 | 2.25 |
| | | | | | | | | | | | (DCMU99) |
| 39 | 21 | 62 | 15 | 8 | 15 | 3 | 0.5 | — | 4 | 4.5 | 2.25 |
| | | | | | | | | | | | (2MI) |
| 40 | 22 | 62 | 15 | 8 | 15 | 3 | 0.5 | — | 4 | 4.5 | 2.25 |
| | | | | | | | | | | | (DMP) |

In a similar manner, details of composition are written also regarding adhesive 2 and adhesive 3 (A, PES, DICY, 2PI) in the Table 1˜3. Regarding adhesives No. 4˜18, one part epoxy resins were prepared by same methods as the above with only compositions of epoxy resin different therefrom. Compositions of epoxy resin of respective No. of adhesives are shown in Table 1. Respective adhesives prepared based on composition of the adhesives No. 4˜18 were named as adhesive 2 (A, PES, DICY, 2PI)˜adhesive 16 (A, PES, DICY, 2PI).

The above A7075 pieces were joined by adhesion using adhesive No. 1 (A, PES, DICY, 2PI)˜adhesive No. 16 (A, PES, DICY, 2PI) in Table 1 to prepare shaped articles (test pieces) as shown in FIGS. 4A and 4B and shear joining strength was measured by breaking the articles of A7075 pieces joined each other. The result is as shown in Table 2 and explained in detail regarding the Experimental Example 19 in Table 2. That is, after 18 plates of A7075 pieces having been subjected to surface treatment in the Experimental Example 1 have been overlaid with adhesive 1 (A, PES, DICY, 2PI), these were placed into a desiccator, which was then closed with a cover. The desiccator is one having been warmed to be 67° C. Then, inside of the desiccator, in which the A7075 pieces were placed, was decompressed and, after about 3 minutes, was returned to an ordinary pressure. This operation of decompression/return to an ordinary pressure was conducted three times (this is treatment of soakage). After this, the A7075 pieces were taken out of the desiccator and every two plates were paired each other with areas overlaid with adhesive of two pieces touching closely each other.

At this time, area for joining was caused to be 0.6˜0.7 cm². Each pair was fixed with a clip to have a shape of test piece shown in FIG. 2. In such a manner, 9 pairs of A7075 pieces joined each other were prepared. Then, inside of a hot air drier was set to be 90° C., and the paired A7075 pieces were placed therein to be heated for 5 minutes. Further, temperature of inside of the hot air drier was raised to 135° C. and the paired A7075 pieces were heated at a temperature of 135° C. for 40 minutes. Furthermore, temperature of inside of the hot air drier was raised to 165° C. and the paired A7075 pieces were heated at a temperature of 165° C. for 30 minutes. After this, having been left cooled, 9 test pieces as pairs of A7075 pieces joined each other were prepared. Next day, the test pieces were broken on a tensile strength test machine. This test was conducted at an ordinary temperature and at 150° C. for three pairs of test pieces for each temperature. In a case where high joining strength was exhibited at 150° C., test at 100° C. was further conducted. Shear breaking strength at the time (average values for three pairs) is shown in Table 2 (Examination Example 19). Further, regarding experimental examples 20˜34, examination similar to the above examination example 19 was conducted using adhesives 2 (A, PES, DICY, 2PI)˜adhesive 16 (A, PES, DICY, 2PI) in place of adhesive 1 (A, PES, DICY, 2PI). Result of each experiment is shown in Table 2.

Regarding adhesives No. 1˜16, state at an ordinary temperature is shown in Table 2. Ones in solid state is shown as “solid state” and ones not in solid state but of high viscosity and difficult for using is shown as “high viscosity”. Further, with adhesives No. 1˜16, as 2-phenylimidazole is used as auxiliary agent of hardener, it was decided whether those adhesives satisfy conditions according to Eqs. (i)˜(iv) as explained above. Ones that satisfy all of conditions according to Eqs. (i)˜(iv) are shown as “O” and ones that do not satisfy some of the conditions are shown as “x”. As shown in Table 2, adhesives exhibited shear breaking strength of more than 30 MPa at 150° C. satisfy all the following conditions according to Eqs. (i)˜(iv).

| | |
|---|---|
| 95 ≥ a + d ≥ 68 | Eq. (i) |
| 32 ≥ c + d ≥ 15 | Eq. (ii) |
| 22 ≥ b ≥ 5 | Eq. (iii) |
| d ≥ 7 | Eq. (iv) |

Regarding adhesive No. 1 in Table 2, a+d=70, being a value near to the lower limit, thus is of high viscosity. Consequently, though it has such disadvantage that overlaying with it is difficult, it satisfies all conditions according to (i)˜(iv), so that it exhibited extremely high heat resistance as 62.8 MPa at an ordinary temperature, 43.3 MPa at 100° C. or 38.0 MPa at 150° C. Regarding also adhesive No. 11, a+d=70, thus providing characteristics similar to adhesive No. 1. Regarding adhesives No. 6 and 8, while a+d=70 similarly as adhesives No. 1 and 11, it has lower viscosity compared with the adhesives No. 1 and 11, thus providing adhesive used easily along with extremely favorable heat resistance. In this, adhesive No. 6 has shear breaking strength of 55.8 MPa at an ordinary temperature, which is lowest among adhesives No. 1, 2, 4, 5, 6, 8, 10, 11, 12, 13 satisfying all conditions according to Eqs. (i)˜(iv).

Regarding adhesive No. 2 in Table 2, a+d=79, so it can be used easily, exhibiting joining strength and heat resistance in the highest level as 71.2 MPa at an ordinary temperature, 57.8 MPa at 100° C. and 42.1 MPa at 150° C. Also, adhesives No. 4, 5, 10, 12 and 13 has characteristics similar to adhesive No. 2. Here, while adhesive No. 12 satisfies all conditions according to Eqs. (i)˜(iv), it does not contain epoxy resin of phenol resin type (c=0). As this also provided favorable result of experiment, if conditions according to Eqs. (i)˜(iv) are satisfied, it has not influence on joining strength or heat resistance whether epoxy resin of phenol resin type is contained or not. In such a manner, it was described that adhesives No. 1, 2, 4, 5, 6, 8, 10, 11, 12 and 13 have high joining strength secured at an ordinary temperature along with heat resistance provided.

On the other hand, regarding adhesive No. 3, as b=4, it does not satisfy condition according to Eq. (iii). Though it exhibited shear breaking strength of 50.2 MPa at an ordinary temperature, it lost joining strength at 100° C., 150° C. That is, it has extremely low heat resistance. Regarding adhesive No. 7, as a+d=65, it does not satisfy condition according to Eq. (i) and is in solid state at an ordinary temperature, so that it was of extremely low practicability. This adhesive No. 7 did not exhibit joining strength by adhesion at all at an ordinary temperature. Regarding adhesive No. 9, as a+d=65 similarly and d=5, it does not satisfy condition according to Eqs. (i) and (iv), it was similar to adhesive No. 7. Regarding adhesive 14, as a+d=67, it does not satisfy condition according to Eq. (i) and has high viscosity at an ordinary temperature. Also, as d=0, it does not satisfy condition according to Eq. (iv). Though the adhesive No. 14 exhibited shear breaking strength of 64.0 MPa and 23.9 MPa at 150° C. and also exhibited high heat resistance compared with conventional adhesives, the heat resistance was inferior compared with adhesives satisfying conditions according to Eqs. (i)˜(iv).

Regarding adhesive No. 15, as a+d=67, it does not satisfy condition according to Eq. (i) and is in solid state at an ordinary temperature. Further, as b=25, it does not satisfy condition according to Eq. (iii). Though this adhesive No. 15 exhibited shear breaking strength of 70.0 MPa at an ordinary temperature and 26.5 MPa at 150° C. and also exhibited high heat resistance compared with conventional adhesive, the heat resistance was inferior compared with adhesives satisfying conditions according to Eqs. (i)˜(iv). Regarding adhesive No. 16, as c+d=11, it does not satisfy condition according to Eq. (ii) and is in solid state at an ordinary temperature. Further, as b=29, it does not satisfy condition according to Eq. (iii). Though this adhesive No. 16 exhibited shear breaking strength of 62.3 MPa at an ordinary temperature and 23.9 MPa at 150° C. and also exhibited high heat resistance compared with conventional adhesive, the heat resistance was inferior compared with adhesives satisfying conditions according to Eqs. (i)˜(iv).

Adhesive No. 17 was prepared in which carbon nanotube “MCNT” is further added to the composition of adhesive No. 4. 100 parts by mass of epoxy resin with 0.1 parts by mass of “MCNT” added to was subjected to destruction dispersion for more than 30 minutes using a sand grinding mill in a similar manner as other filler. Composition of the adhesive No. 17 obtained thereby is shown in Table 3. Further, composition of prepared adhesive No. 18 is one in which “PES4100M” is removed from the composition of adhesive No. 4. That is, “PES4100MP” is not added during operation of the sand grinding mill. Further, adhesive No. 19 (PES, DICY, 2PI) is one in which “PES4100M” is equivalent to have prepared adhesive No. 18 in which “Aerosile R805” is removed from the composition of adhesive No. 4 and has same composition as composition of adhesive No. 19 in which “Aerosil 805” is not added during operation of the sand grinding mill.

Further, regarding composition of adhesive No. 4, one was prepared in which “DCMU99” as fine powder of 3-(3,4-dichlorophenyl)-1,1-dimethylurea is used in place of auxiliary agent of hardener “2PI”, and it was taken as adhesive No. 20 (A, PES, DICY, DCMU). While the above Eqs. (i)˜(iv) are applied in such a case, composition of epoxy resin in the adhesive No. 20 also satisfies these conditions.

Further, regarding composition of adhesive No. 4, one was prepared in which fine powder of 2-methylimidazole “2 MI” is used in place of auxiliary agent of hardener “2PI”, which was taken as adhesive No. 21 (A, PES, DICY, 2 MI). The following Eqs. (v)˜(viii) are applied, as auxiliary agent of hardener is 2-methylimidazole.

| | |
|---|---|
| 95 ≥ a + d ≥ 68 | Eq. (v) |
| 30 ≥ c + d ≥ 18 | Eq. (ii) |
| 22 ≥ b ≥ 5 | Eq. (iii) |
| d ≥ 10 | Eq. (iv) |

Composition of epoxy resin of adhesive No. 21 satisfies all conditions according to Eqs. (v)˜(viii).

Further, regarding composition of adhesive No. 4, one was prepared in which N,N′-dimethylpiperazine “Dimethylpiperazine” is used in place of auxiliary agent of hardener “2PI”, and it was taken as adhesive No. 22 (A, PES, DICY, DMP). Eqs. (v)˜(viii) are applied, as auxiliary agent of hardener is N,N′-dimethylpiperazine. Composition of epoxy resin of adhesive No. 22 satisfies all of conditions according to Eqs. (v)˜(viii).

Further, not only mixing recipe of epoxy resin, additive, polymerization initiator and auxiliary agent thereof, etc., but also conditions for using adhesive, etc., for preparing adhesives are explained in detail in Patent Document 8. While data of shear joining strength by adhesion of pairs of Al alloy A7075 pieces having been subjected to NAT treatment each other are reported there, these are omitted here, and Tables 4˜11 of Patent Document 8 are shown here.

TABLE 4

| | | | | | | | | | | | | | Shear |
|---|---|---|---|---|---|---|---|---|---|---|---|---|---|
| Experi- | | | | | | | | | | | Eqs. of | Eqs. of | breaking |
| mental | | | | | | | Epoxy resin | | | | condition | condition | strength |
| example | Adhesive | Name | | | | | a | b | c | d | (i)-(iv) | (v)-(viii) | (150° C.) |
| 22 | 4 | A | | PES | DICY | 2PI | 62 | 15 | 8 | 15 | ◯ | — | 44.3 |
| 41 | 17 | A | MCNT | PES | DICY | 2PI | 62 | 15 | 8 | 15 | ◯ | — | 42.3 |
| 42 | 18 | A | | | DICY | 2PI | 62 | 15 | 8 | 15 | ◯ | — | 43.5 |
| 43 | 19 | | | PES | DICY | 2PI | 62 | 15 | 8 | 15 | ◯ | — | 34.7 |
| 44 | 20 | A | | PES | DICY | DCMU | 62 | 15 | 8 | 15 | ◯ | — | 30.5 |
| 45 | 21 | A | | PES | DICY | 2MI | 62 | 15 | 8 | 15 | — | ◯ | 28.2 |
| 46 | 22 | A | | PES | DICY | DMP | 62 | 15 | 8 | 15 | — | ◯ | 28.8 |

TABLE 5

| | | | | | | | Ultrafine | | Thermo | | |
|---|---|---|---|---|---|---|---|---|---|---|---|
| | | | | | | Inorganic | inorganic | | plastic | | Auxiliary |
| Experi- | | | | | | filler | filler | Carbon | resin | | agent of |
| mental | | Epoxy resin | | | | Himicron | Aerosil | nanotube | powder | Hardener | hardener |
| example | Adhesive | JER828 | JER1004 | JER154 | JER630 | HE5 | R805 | MCNT | PES4100MP | DICY7 | 2PI |
| 47 | 23 | 62 | 15 | 8 | 15 | 3 | 0.5 | — | 4 | 2.5 | 1.25 |
| 48 | 24 | 62 | 15 | 8 | 15 | 3 | 0.5 | — | 4 | 3.5 | 1.75 |
| 6 | 4 | 62 | 15 | 8 | 15 | 3 | 0.5 | — | 4 | 4.5 | 2.25 |
| 49 | 25 | 62 | 15 | 8 | 15 | 3 | 0.5 | — | 4 | 5.5 | 2.75 |

TABLE 6

| Experi- | | | | | | | Auxiliary agent | Shear breaking |
|---|---|---|---|---|---|---|---|---|
| mental | | | | | | Hardener | of hardener | strength at |
| example | Adhesive | Name | | | | DICY7 | 2PI | 150° C. (Mpa) |
| 50 | 23 | A | PES | DICY | 2PI | 2.5 | 1.25 | 33.2 |
| 51 | 24 | A | PES | DICY | 2PI | 3.5 | 1.75 | 42.5 |
| 22 | 4 | A | PES | DICY | 2PI | 4.5 | 2.25 | 44.3 |
| 52 | 25 | A | PES | DICY | 2PI | 5.5 | 2.75 | 36.3 |

TABLE 7

| Experi- | | | | | | | Shear breaking |
|---|---|---|---|---|---|---|---|
| mental | | | | | | Condition of | strength at ordinary |
| example | Adhesive | Name | | | | hardening | temperature (Mpa) |
| 22 | 4 | A | PES | DICY | 2PI | for 40 min. at 135° C. | 67.5 |
| | | | | | | for 30 min. at +165° C. | |
| 56 | 4 | A | PES | DICY | 2PI | for 60 min. at 170° C. | 72.5 |
| 57 | 4 | A | PES | DICY | 2PI | for 60 min. at 110° C. | 28.5 |
| 58 | 4 | A | PES | DICY | 2PI | for 60 min. at 120° C. | 65.3 |
| 59 | 4 | A | PES | DICY | 2PI | for 60 min. at 130° C. | 67.4 |

TABLE 8

| Experi- | | | | | | | Shear breaking |
|---|---|---|---|---|---|---|---|
| mental | | | | | | Condition of | strength (Mpa) at |
| example | Adhesive | Name | | | | hardening | ordinary temperature |
| 44 | 20 | A | PES | DICY | DCMU | for 40 min. at 135° C. | 68.5 |
| | | | | | | for 30 min. at +165° C. | |
| 60 | 20 | A | PES | DICY | DCMU | for 60 min. at 170° C. | 73.3 |
| 61 | 20 | A | PES | DICY | DCMU | for 60 min. at 100° C. | 55.5 |
| 62 | 20 | A | PES | DICY | DCMU | for 60 min. at 110° C. | 66.3 |
| 63 | 20 | A | PES | DICY | DCMU | for 60 min. at 120° C. | 65.4 |

TABLE 9

| | | | | | | Shear breaking | |
|---|---|---|---|---|---|---|---|
| Experi- | | | | | | strength (Mpa) | |
| mental | | | | | | Ordinary | |
| example | Adhesive | Name | | | | temperature | 100° C. |
| 64 | 4 | A | PES | DICY | 2PI | 41.6 | 40.8 |
| 65 | Commercially | EP106NL | | | | 42.0 | 19.9 |
| | available | | | | | | |
| 66 | Commercially | EP160 | | | | 41.5 | 24.3 |
| | available | | | | | | |

TABLE 10

| | | | | | | | | Shear breaking | |
|---|---|---|---|---|---|---|---|---|---|
| Experi- | | | | | | | | strength (Mpa) | |
| mental | | | | | | | Thickness | Ordinary | |
| example | Metal alloy | Adhesive | Name | | | | (mm) | temperature | 100° C. |
| 64 | Al alloy A5052 | 4 | A | PES | DICY | 2PI | 1.6 | 41.6 | 40.8 |
| 65 | Al alloy A5052 | Commercially | EP106NL | | | | 1.6 | 42.0 | 19.9 |
| | | available | | | | | | | |
| 67 | Al alloy A7075 | 4 | A | PES | DICY | 2PI | 3.0 | ≤6 | ≤6 |
| 68 | Al alloy A7075 | Commercially | EP106NL | | | | 3.0 | ≤6 | ≤6 |
| | | available | | | | | | | |
| 69 | Copper alloy C1100 | 4 | A | PES | DICY | 2PI | 1.4 | 45.6 | 42.9 |
| 70 | Copper alloy C1100 | Commercially | EP106NL | | | | 1.4 | 47.3 | 25.9 |
| | | available | | | | | | | |
| 71 | Copper alloy KFC | 4 | A | PES | DICY | 2PI | 0.9 | 45.6 | 43.9 |
| 72 | Copper alloy KFC | Commercially | EP106NL | | | | 0.9 | 47.0 | 20.7 |
| | | available | | | | | | | |
| 73 | Titanium alloy KS-40 | 4 | A | PES | DICY | 2PI | 1.0 | 29.6 | 23.9 |
| 74 | Titanium alloy KS-40 | Commercially | EP106NL | | | | 1.0 | 24.0 | 13.3 |
| | | available | | | | | | | |
| 75 | Stainless steel SUS304 | 4 | A | PES | DICY | 2PI | 1.0 | 48.6 | 40.9 |
| 76 | Stainless steel SUS304 | Commercially | EP106NL | | | | 1.0 | 47.5 | 13.2 |
| | | available | | | | | | | |
| 77 | Cold rolled steel material | 4 | A | PES | DICY | 2PI | 1.6 | 61.6 | 46.9 |
| | SPCC | | | | | | | | |
| 78 | Cold rolled steel material | Commercially | EP106NL | | | | 1.6 | 62.1 | 22.3 |
| | SPCC | available | | | | | | | |

TABLE 11

| | | | | | | | Ultrafine | | | | |
|---|---|---|---|---|---|---|---|---|---|---|---|
| | | | | | | Inorganic | inorganic | | | | Auxiliary |
| Experi- | | | | | | filler | filler | Carbon | | | agent of |
| mental | | Epoxy resin | | | | Himicron | Aerosil | nanotube | Powder | Hardener | hardener |
| example | Adhesive | JER828 | JER1004 | JER154 | JER630 | HE5 | R805 | MCNT | PES4100MP | DICY7 | 2PI |
| 6 | 4 | 62 | 15 | 8 | 15 | 3 | 0.5 | — | 4 | 4.5 | 2.25 |
| 79 | 25 | 62 | 15 | 8 | 15 | 3(Satenton5) | 0.5 | — | 4 | 4.5 | 2.25 |
| 80 | 26 | 62 | 15 | 8 | 15 | 3 | 0.5 | — | 4(Aluminum) | 4.5 | 2.25 |
| 81 | 27 | 62 | 15 | 8 | 15 | 3(Satenton5) | 0.5 | — | 4(Aluminum) | 4.5 | 2.25 |

TABLE 12

| | | | | Shear breaking | |
|---|---|---|---|---|---|
| | | | | strength (Mpa) | |
| Experimental | | Inorganic | | Ordinary | 150° |
| example | Adhesive | filler | Powder | temperature | C. |
| 22 | 4 | Himicron | PES4100MP | 67.5 | 44.3 |
| | | HE5 | | | |
| 82 | 25 | Satenton 5 | PES4100MP | 70.8 | 43.5 |
| 83 | 26 | Himicron | Aluminum | 77.3 | 44.5 |
| | | HE5 | powder for | | |
| | | | filler | | |
| 84 | 27 | Satenton 5 | Aluminum | 75.9 | 45.0 |
| | | | powder for | | |
| | | | filler | | |

In this, Table 2 does not show result of experiment in which a test piece is overlaid with adhesive (in solid state at an ordinary temperature) in melted state, vacuum operation, etc., is applied in the melted state, after this, the adhesive is subjected to hardening reaction for 20 minutes at 150° C. and shear joining strength by adhesion is measured. Such data will be shown below. That is, with one as adhesive No. 7 and in a solid state in Table 2, ratio of composition of epoxy resin is 55:20:15:10 as shown in Table 1, and shear joining strength was 58.0 MPa at an ordinary temperature and 30.5 MPa at 150° C. While the value at an ordinary temperature was somewhat lower than 60 MPa, suitably high strength was exhibited at a high temperature, though not sufficient one.

It is considered that adhesives with performance thereof that should be used in the present invention as suitable are “EW2040” as one commercially available, one as adhesive No. 7 in Table 2 of Patent Document 8 with which manner of use is operation of overlaying at 50° C.˜60° C. and operation of air vent from overlaid layer after overlaying also at 50° C.˜60° C., or one having recipe of epoxy resin very near to adhesive No. 7.

### Preparation Example of Hardened Adhesive

Hardened adhesives used in the present invention are the above adhesives having been solidified preliminarily to have plate shape (not limited to, different according to area of adhesion) and serve as a kind of cushioning material or follower following to mechanical stress or thermal contraction when metal alloy material and CFRP material are joined to be an integrated article by adhesion. Summary of a method of preparing such hardened adhesive in a case of plate shape will be explained. A container open in upper portion with an area same as the area of adhesion and not damaged at a temperature below about 150° C. is prepared. This container is a liquid bath as a pool shaped concave having an outer frame of a shape with an area same as the area of adhesion and having a depth of about 5 mm. A suitable amount of adhesive of designation 1 or 2 selected for use, strength, etc., is taken into the pool shaped concave. Then, the adhesive contained in the liquid bath having the pool shaped concave is taken into an autoclave. Operation of bringing the autoclave into vacuum state at about 70° C. and then returning it to an ordinary pressure is repeated to extract air contained in the adhesive. After this, raising temperature, these are held there for 20 minutes at about 150° C. and then left cooled. After left cooled, solidified and hardened plate shaped adhesive is taken out of the liquid bath to be a hardened adhesive having a thickness of about 2˜3 mm. As explained later, all faces of upper, lower and side faces of the hardened adhesive are made to be of fine irregularities by mechanical working of polishing with sand paper, grindstone, etc., in order to raise joining strength by adhesion, after which the hardened adhesive is cleaned with water, etc., to be a plate shaped article having smooth and flattened faces. Such finished hardened adhesive is used in the present invention.

### Example of Using Method of Hardened Adhesive

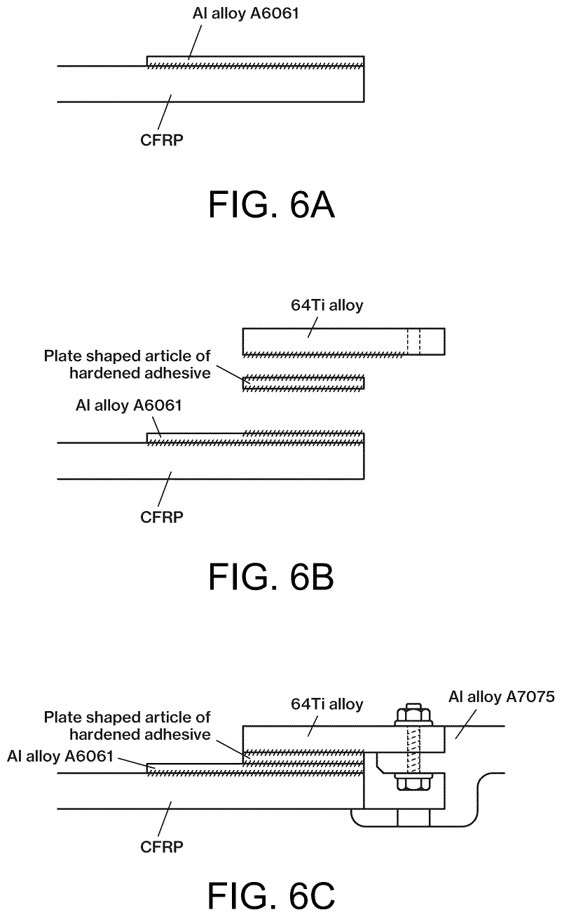

In the present invention, when a CFRP material and a metal material for structure, etc., are to be fixedly joined, these are joined by adhesion with a sheet or plate shaped hardened adhesive intervening between these. FIGS. 6A˜6C show an example of joined structure in which plate shaped hardened adhesive is used as an intervening material when a CFRP plate material and a plate material of Al alloy A7075 (ultra-super duralumin) as a structural part are joined by mechanical joining means. As shown in FIG. 6A, a CFRP plate and an Al alloy A6061 sheet are joined by adhesion preliminarily. An Al alloy A6061 sheet has high expandability and thermal conductivity along with high followability to thermal shrinkage or elastic deformation due to mechanical load of the CFRP plate material. In this, such metal sheet is not limited to Al alloy but may be a sheet of material such as steel sheet, if it can follow to thermal shrinkage of CFRP plate (see Patent Document 12). Faces having fine irregularities are formed on upper and lower faces of a plate shaped hardened adhesive prepared separately. Such faces having fine irregularities are formed by mechanical working means with sand paper, grindstone, etc., and the faces are cleaned by supersonic waves, etc.

Faces with fine irregularities most suitable for adhesion are formed on faces of a 64Ti alloy plate as an intermediate material (a kind of cushion material) in a joining structure by chemical treatment (see Patent Document 4). Finally, faces with fine irregularities are formed also on faces for adhesion of the Al alloy A6061 sheet by chemical treatment or mechanical working. After these preliminary steps, faces for adhesion of the Al alloy A6061 sheet, upper and lower faces of the hardened adhesive and faces for adhesion of the 64Ti alloy plate are overlaid with liquid adhesive, and these are subjected to thermal curing by such a usual method as not creating bubbles in a decompressed circumference. Such a joined structure is prepared that the 64Ti alloy plate and the Al alloy A7075 plate are joined with bolt-nut and further the CFRP plate and the Al alloy A7075 plate are joined together. In this, 64Ti is precisely named as “JIS60 species” or “TAB6400”.

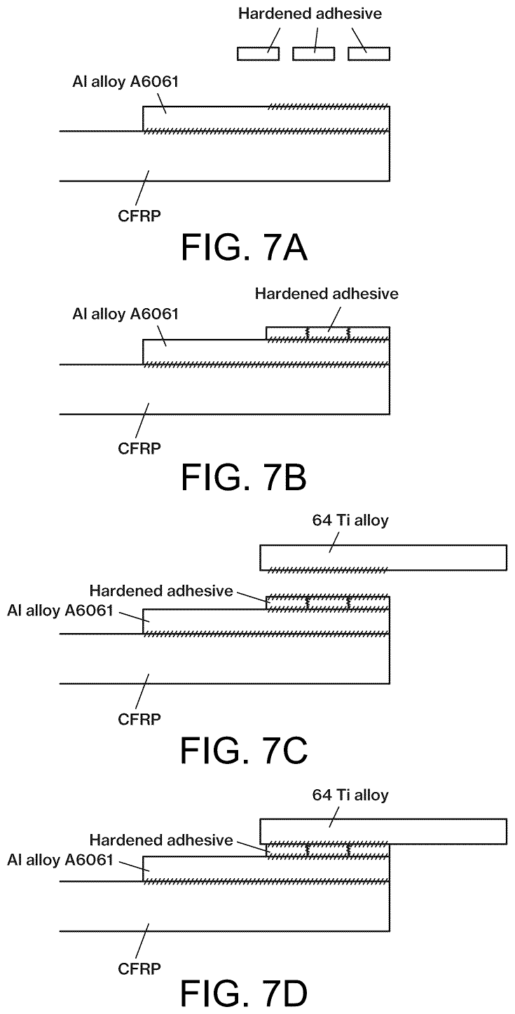

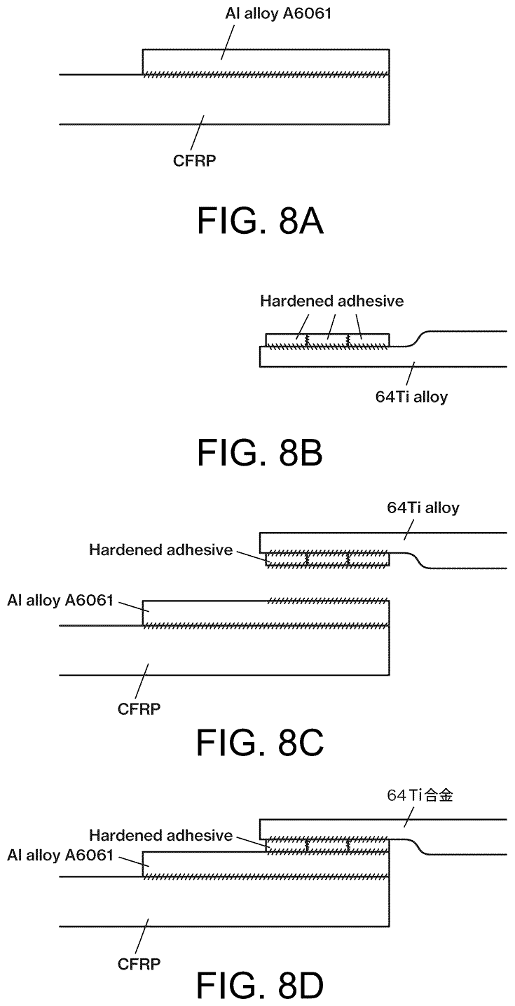

FIGS. 7A˜7D show an example of joined structure in which a CFRP plate and a 64Ti alloy plate are joined by adhesion with an intervening member of a plate shaped hardened adhesive. While the structure shown in FIGS. 7A˜7D is substantially same as one shown in FIGS. 6A˜6C, they are different in steps of adhesion. That is, in the example shown in FIGS. 7A˜7D, only one face of the hardened adhesive is joined by adhesion in each individual step. Due to this, operation of adhesion can be conducted easily and thermal strain created in adhesion becomes little. Method of hardening adhesive by heating, forming faces of adhesion with fine irregularities, etc., are similar to ones shown in FIGS. 6A˜6C. In a similar manner, an example of joined structure shown in FIGS. 8A˜8D in which a CFRP plate and a 64Ti alloy plate are joined by adhesion with an intervening member of a plate shaped hardened adhesive. While the joined structure shown in FIGS. 8A˜8D is substantially same as ones shown in FIGS. 6A˜6C or FIGS. 7A˜7D, they are different in step of adhesion. That is, in the example shown in FIGS. 8A˜8D, the hardened adhesive is joined by adhesion to the Al alloy A6061 plate after only one face of the hardened adhesive has been joined by adhesion to the 64Ti alloy plate.

### (Adhesion of Al Alloy A7075 (Ultra-Super Duralumin) Plates Each Other)

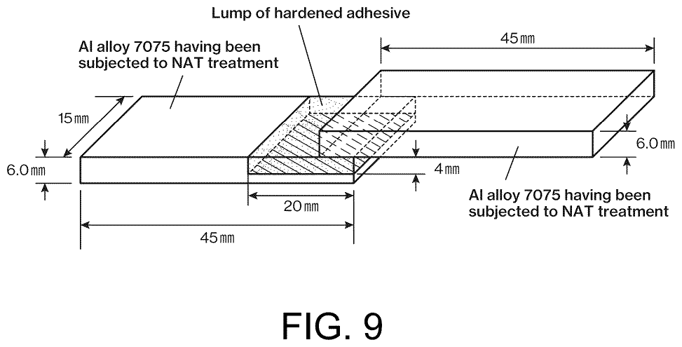

FIG. 9 is a perspective view showing a test piece in which Al alloy A 7075 materials are joined each other by NAT type adhesion with hardened adhesive intervened between these and for which shear joining strength by adhesion is measured. While FIG. 9 does not show an example of joined structure, it can be used also as a joined structure in which Al alloy A7075 materials are joined directly by adhesion each other. Method of surface treatment Al alloy A7075 materials and a hardened adhesive and method of adhesion are not different from ones explained referring FIGS. 6A˜8D.

What is claimed is:

1. An integrated article by adhesion of a metal alloy material for structure with a CFRP material in which a metal plate material is integrated with a CFRP plate material with adhesive, comprising:
a CFRP plate material and a metal alloy plate material, in which one face of the metal plate material is joined by adhesion with thermosetting adhesive to the CFRP plate material to be integrated,
a hardened adhesive in which one face of the hardened adhesive is joined by adhesion with the thermosetting adhesive to the other face of the metal plate material for an area narrower than the one face of the metal plate material and the thermosetting adhesive is cured by heating, and
an intermediate material joined by adhesion with the thermosetting adhesive to the other face of the hardened adhesive.

2. The integrated article by adhesion of a metal alloy material for structure with a CFRP material according to claim 1, wherein:
the metal alloy plate material is an aluminum alloy plate material,
the hardened adhesive has no less than one uniform plate shaped thickness, and
the intermediate material is a Ti alloy material.

3. The integrated article by adhesion of a metal alloy material for structure with a CFRP material according to claim 2, wherein:
the hardened adhesive is one part epoxy resin adhesive,
the metal alloy plate material is an aluminum alloy A6061 by JIS,
the metal alloy material for structure is an aluminum alloy of a type Al—Zn—Mg—Cu, and
the Ti alloy material is of “JIS60 species” and fastened to the metal alloy material by mechanical fixing means.

4. A method for assembling the integrated article by adhesion of a metal alloy material for structure with a CFRP material according to claim 2, comprising:
a step of forming faces with fine irregularities by forming faces with fine irregularities on the one face and the other face of the CFRP plate material and the aluminum alloy plate by chemical treatment or mechanical working before adhesion of the CFRP plate material with the aluminum alloy plate material,
a step of joining the CFRP plate material with the aluminum alloy by adhesion,
a step of working on the front and backside faces of the hardened adhesive by forming faces with fine irregularities on one face and the other face as front face and backside face of the hardened adhesive by mechanical working, and
a step of joining Ti alloy material by adhesion of joining the one face of the hardened adhesive onto the other face of the aluminum alloy plate by adhesion with the thermoplastic adhesive and joining the Ti alloy material onto the other face of the hardened adhesive by adhesion with the thermosetting adhesive.

5. A method for assembling the integrated article by adhesion of a metal alloy material for structure with a CFRP material according to claim 4, wherein
the step of joining by adhesion of joining the CFRP plate material with the aluminum alloy by adhesion and the step of joining Ti alloy material by adhesion are conducted in a decompressed circumference.
